(19) United States
(12) Patent Application Publication
(10) Pub. No.: US 2017/0132821 A1
(43) Pub. Date: May 11, 2017

(54) CAPTION GENERATION FOR VISUAL MEDIA

(71) Applicant: MICROSOFT TECHNOLOGY LICENSING, LLC, Redmond, WA (US)

(72) Inventors: JAMIL VALLIANI, KIRKLAND, WA (US); RYAN BECKER, REDMOND, WA (US); GAURANG PRAJAPATI, KIRKLAND, WA (US); ARUN SACHETI, SAMMAMISH, WA (US); SOO HOON CHO, BELLEVUE, WA (US)

(21) Appl. No.: 15/044,961

(22) Filed: Feb. 16, 2016

Related U.S. Application Data
(60) Provisional application No. 62/252,254, filed on Nov. 6, 2015.

(51) Int. Cl. G06T 11/60; G06K 9/62; G06F 17/24

(52) U.S. Cl. CPC G06T 11/60; G06F 17/241; G06K 9/6267; G06F 17/248; G06F 3/0484

(57) ABSTRACT

Aspects of the technology described herein automatically generate captions for visual media, such as a photograph or video. The caption can be presented to a user for adoption and/or modification. If adopted, the caption could be associated with the image and then forwarded to the user's social network, a group of users, or any individual or entity designated by a user. The caption is generated using data from the image in combination with signal data received from a mobile device on which the visual media is present. The data from the image could be gathered via object identification performed on the image. The signal data can be used to determine a context for the image. The signal data can also help identify other events that are associated with the image, for example, that the user is on vacation. The caption is built using information from both the picture and context.

### CROSS REFERENCE TO RELATED APPLICATIONS

This application claims the benefit of U.S. Provisional Application No. 62/252,254, filed Nov. 6, 2015, the entirety of which is hereby incorporated by reference.

### BACKGROUND

Automatically captioning digital images continues to be a technical challenge. A caption can be based on both the content of a picture and a purpose for taking the picture. The exact same picture could be associated with a different caption depending on context. For example, an appropriate caption for a picture of fans at a baseball game could differ depending on the score of the game and for which team the fan is cheering.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

Aspects of the technology described herein automatically generate captions for visual media, such as a photograph or video. The visual media can be generated by the mobile device, accessed by the mobile device, or received by the mobile device. The caption can be presented to a user for adoption and/or modification. If adopted, the caption could be associated with the image and then forwarded to the user's social network forward to a group of users, or any individual or entity designated by a user. Aspects of the technology do not require that a caption be adopted or modified. For example, the caption could be presented to the user for information purposes as a memory prompt (e.g., “you and Ben at Julie's wedding”) or entertainment purposes (e.g., “Your hair looks good for rainy day.”).

The caption is generated using data from the image in combination with signal data received from a mobile device on which the visual media is present. The data from the image could be metadata associated with the image or gathered via object identification performed on the image. For example, people, places, and objects can be recognized in the image. The signal data can be used to determine a context for the image. For example, the signal data could indicate that the user was in a particular restaurant when the image was taken. The signal data can also help identify other events that are associated with the image, for example, that the user is on vacation, just exercised, etc. The caption is built using information from both the picture and context.

### BRIEF DESCRIPTION OF THE DRAWINGS

Aspects of the technology described in the present application are described in detail below with reference to the attached drawing figures, wherein:

FIG. 1 is a block diagram of an exemplary computing environment suitable for implementing aspects of the technology described herein;

FIG. 2 is a diagram depicting an exemplary computing environment that can be used to generate captions, in accordance with an aspect of the technology described herein;

FIG. 3 is a diagram depicting a method of generating a caption for a visual media, in accordance with an aspect of the technology described herein;

FIG. 4 is a diagram depicting a method of generating a caption for a visual media, in accordance with an aspect of the technology described herein;

FIG. 5 is a diagram depicting a method of generating a caption for a visual media, in accordance with an aspect of the technology described herein;

FIG. 6 is a diagram depicting an exemplary computing device, in accordance with an aspect of the technology described herein;

FIG. 7 is a diagram depicting a caption presented as an overlay on an image, in accordance with an aspect of the technology described herein;

FIG. 8 is a table depicting age detection caption scenarios, in accordance with an aspect of the technology described herein;

FIG. 9 is a table depicting celebrity match caption scenarios, in accordance with an aspect of the technology described herein;

FIG. 10 is a table depicting coffee-based caption scenarios, in accordance with an aspect of the technology described herein;

FIG. 11 is a table depicting beverage-based caption scenarios, in accordance with an aspect of the technology described herein;

FIG. 12 is a table depicting situation-based caption scenarios, in accordance with an aspect of the technology described herein;

FIG. 13 is a table depicting object-based caption scenarios, in accordance with an aspect of the technology described herein; and

FIG. 14 is a table depicting miscellaneous caption scenarios, in accordance with an aspect of the technology described herein.

### DETAILED DESCRIPTION

The technology of the present application is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Aspects of the technology described herein automatically generate captions for visual media, such as a photograph or video. The visual media can be generated by the mobile device or received by the mobile device. The caption can be presented to a user for adoption and/or modification. If adopted, the caption could be associated with the image and then forwarded to the user's social network, a group of users, or any individual or entity designated by a user. Alternatively, the caption could be saved to computer storage as meta data associated with the image. Aspects of the technology do not require that a caption be adopted or modified. For example, the caption could be presented to the user for information purposes as a memory prompt (e.g., “you and Ben at Julie's wedding”) or entertainment purposes (e.g., “Your hair looks good for rainy day.”).

The caption is generated using data from the image in combination with signal data received from a mobile device on which the visual media is present. The data from the image could be meta data associated with the image or via object identification performed on the image. For example, people, places, and objects can be recognized in the image.

The signal data can be used to determine a context for the image. For example, the signal data could indicate that the user was in a particular restaurant when the image was taken. The signal data can also help identify other events that are associated with the image, for example, that the user is on vacation, just exercised, etc. The caption is built using information from both the picture and context.

The signal data gathered by a computing device can be mined to extract event information. Event information describes an event the user has or will participate in. For example, an exercise event could be detected in temporal proximity to taking a picture. In combination with an image of nachos, a caption could be generated stating “nothing beats a plate of nachos after a five-mile run.” The nachos could be identified through image analysis of an active photograph being viewed by the user. The running event and distance of the run could be extracted from event information. For example, the mobile device could include an exercise tracker or be linked to a separate exercise tracker that provides information about heart rate and distance traveled to the mobile device. The mobile device could look at the exercise data and associate it with an event consistent with an exercise pattern, such as a five-mile run.

The caption could be generated by first identifying a caption scenario that is mapped to both an image and an event. For example, a scenario could include an image of food in combination with an exercise event. Further analysis or classification could occur based on whether the food is classified as healthy or indulgent. If healthy, one or more caption templates associated with the consumption of healthy food in conjunction with exercise could be selected. The caption templates could include insertion points where details about the exercise event can be inserted, as well as a description of the food.

In one aspect, a technology described herein receives an image. The image may be an active image displayed in an image application or other application on the user device. In one aspect, the image is specifically sent to a captioning application by the user or a captioning application is explicitly invoked in conjunction with an active image. In another aspect, captions are automatically generated without a user request, for example, by a personal assistant application.

In one aspect, the user selects a portion of the image that is associated with a recognizable object. The portion of the image may be selected prior to recognition of an object in the image by the technology described herein. Alternatively, objects that are recognizable within the image could be highlighted or annotated within the image for user selection. For example, an image of multiple people could have individual faces annotated with a selection interface. The user could then select one of the faces or more for caption generation. The user may select a portion of the image by placing their finger on a portion of the image, by lassoing part of the image by drawing a circle with their finger or a stylus, or through some other mechanism.

In one aspect, a selection interface is only presented when multiple scenario-linked objects are present in the image. Scenario-linked objects are those tied to a caption scenario. For example, a picture could depict a dog and a park bench. If the dog is tied to a caption scenario and the park bench is not, then the dog is a scenario-linked object and the park bench is not.

A selected object may be assigned an object classification using an image classifier. An image classifier may comprise a database of images along with human annotation data identifying objects depicted in the images. The database of images are then used to train a classifier that can receive unmarked images to an identify objects in the images. For example, a collection of images of shoes could be used to identify a shoe in an unmarked image through an image analysis and classification that looks for similarity between the images and training images of shoes.

The technology described herein can then analyze signal data from the mobile device to match the signal data to an event. Different events can be associated with different signal data. For example, a travel event could be associated with GPS and accelerometer data indicating a distance and velocity traveled that is consistent with a car, a bike, public transportation, or some other method. An exercise event could be associated with physiological data associated with exercise. A purchase event could be associated with web browsing activity and/or credit card activity indicating a purchase. A shopping event could be associated with the mobile device being located in a particular store or shopping area. An entertainment event could be associated with being located in an entertainment district. Other events and event classifications can be derived from signal data. Once an event is detected, semantic knowledge about the user can be mined to find additional information about the event. For example, consider a picture of a girl in a soccer uniform. The knowledge base could be mined to identify the name of the girl, for example, she may be the daughter of a person viewing the picture. Other information in the sematic knowledge base could include a park at which the soccer game is played, and perhaps other information derived from the user's social network, such as a team name. Information from pervious user-generated captions in the user's social network could be mined to include in the sematic knowledge base. A similarity analysis between a current picture and previously posted pictures could be used to help generate a caption.

The object classification derived from the image along with event data derived from the signal data are used in combination to identify a caption scenario and ultimately generate a caption. In one aspect, the caption scenario is a heuristic or rule-based system that includes image classifications and event details and maps both to a scenario. In addition to object data and event details, user data can also be associated with a particular scenario. For example, the age of the user or other demographic information could be used to select a particular scenario. Alternatively, the age or demographic information could be used to select one of multiple caption templates within the scenario. For example, some caption scenarios may be written in slang used by a ten-year-old while another group of caption templates are more appropriate for an adult.

In one aspect, a user's previous use of suggested captions is tracked and the suggested caption is selected according to a rule that distributes the selection of captions in a way that the same caption is not selected for consecutive pictures or other rules.

The caption template can include text describing the scenario along with one or more insertion points. The insertion points receive text associated with the event and/or the object. In combination, the text and object or event data can form a phrase describing or related to the image.

The caption is then presented to the user. In one aspect, the caption is presented to the user as an overlay over the image. The overlay can take many different forms. In one aspect, the overlay takes the form of a textbox, as might be shown in a cartoon. Other forms are possible. The caption can also be inserted as text in a communication, such as a social post, email, or text message.

The user may adopt or edit the caption. The user can use a text editor to modify the caption prior to saving. If adopted, the caption can be associated with the image by forming an embedded overlay or as metadata associated with the image. The image, along with the overlay information, can then be communicated to one or more recipients designated by the user. For example, the user may choose to post the image and associated caption on one or more social networks. Alternatively, the user could communicate the image to a designated group of persons via text, email, or through some other communication mechanism. Finally, the user could choose to save the picture for later use in their photo album along with the associated caption.

The term “event” is used broadly herein to mean any real or virtual interaction between a user and another entity. Events can include communication events, which refers to nearly any communication received or initiated by a computing device associated with a user including attempted communications (e.g., missed calls), communication intended for the user, initiated on behalf of the user, or available for the user. The communication event can include sending or receiving a visual media. Captions associate with the visual media can be extracted from the communication for analysis. The captions can form user data. The term “event” may also refer to a reminder, task, announcement, or news item (including news relevant to the user such as local or regional news, weather, traffic, or social networking/social media information). Thus, by way of example and not limitation, events can include voice/video calls; email; SMS text messages; instant messages; notifications; social media or social networking news items or communications (e.g., tweets, Facebook posts or “likes”, invitations, news feed items); news items relevant to the user; tasks that a user might address or respond to; RSS feed items; website and/or blog posts, comments, or updates; calendar events, reminders, or notifications; meeting requests or invitations; in-application communications including game notifications and messages, including those from other players; or the like. Some communication events may be associated with an entity (such as a contact or business, including in some instances the user himself or herself) or with a class of entities (such as close friends, work colleagues, boss, family, business establishments visited by the user, etc.). The event can be a request made of the user by another. The request can be inferred through analysis of signals received through one or more devices associated with the user.

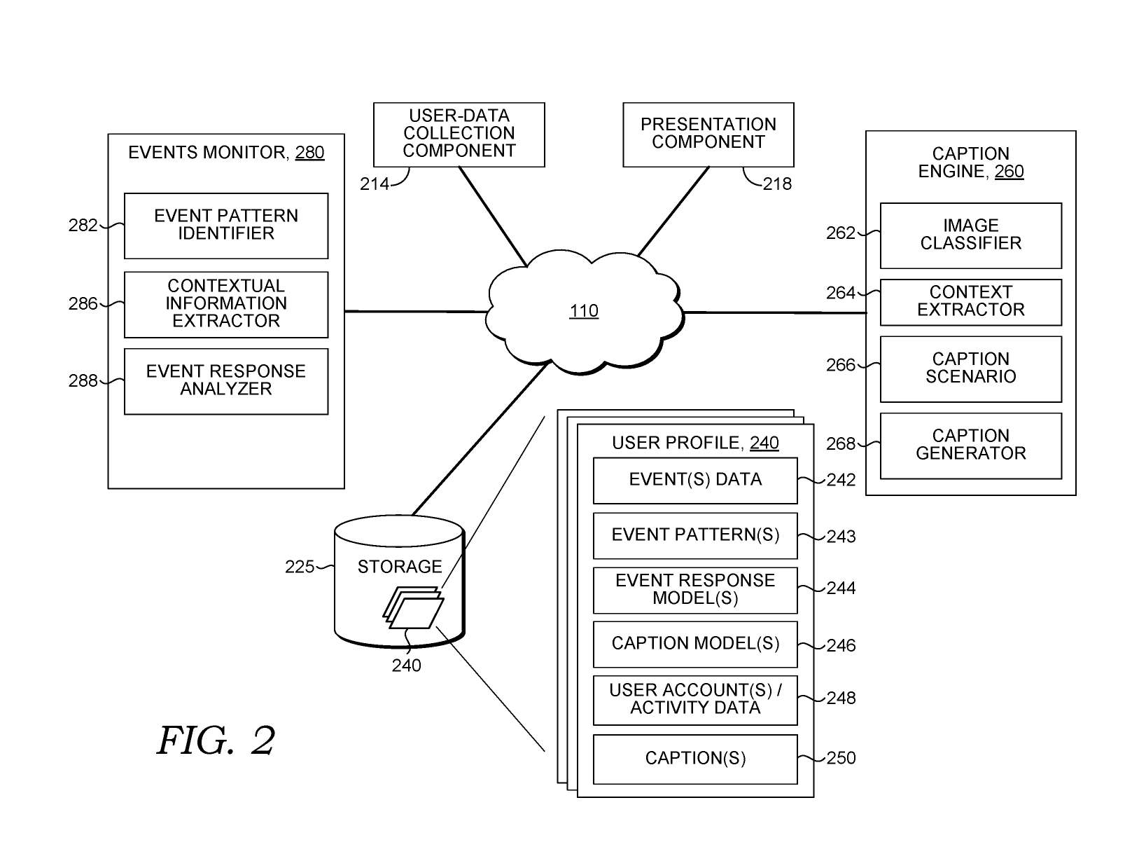

Accordingly, at a high level, in one embodiment, user data is received from one or more data sources. The user data may be received by collecting user data with one or more sensors on user device(s) associated with a user, such as described herein. Examples of user data, which is further described in connection to component 214 of FIG. 2, may include location information of the user's mobile device(s), user-activity information (e.g., app usage, online activity, searches, calls), application data, contacts data, calendar and social network data, or nearly any other source of user data that may be sensed or determined by a user device or other computing device.

Events and user responses to those events, especially those related to visual media, may be identified by monitoring the user data, and from this, event patterns may be determined. The event patterns can include the collection and sharing of visual media along with captions, if any, associated with the media. In one aspect, a pattern of sharing images is recognized and used to determine when captions should or should not be automatically generated. For example, when a user typically shares a picture of food taken in a restaurant along with a caption, then the technology described herein can automatically generate a caption when a user next takes a picture in a restaurant. The event pattern can include whether or not a user completes regularly scheduled events, typically responds to a request within a communication, etc. Contextual information about the event may also be determined from the user data or patterns determined from it, and may be used to determine a level of impact and/or urgency associated with the event. In some embodiments, contextual information may also be determined from user data of other users (i.e., crowdsourcing data). In such embodiments, the data may be de-identified or otherwise used in a manner to preserve privacy of the other users.

Some embodiments of the invention further include using user data from other users (i.e., crowdsourcing data) for determining typical user media sharing and caption patterns for events of similar types, caption logic, and/or relevant supplemental content. For example, crowdsource data could be used to determine what types of events typically result in users sharing visual media. For example, if many people in a particular location on a particular day are sharing images, then a media-sharing event may be detected and captions automatically generated when a user takes a picture at the location on the particular day.

Additionally, some embodiments of the invention may be carried out by a personal assistant application or service, which may be implemented as one or more computer applications, services, or routines, such as an app running on a mobile device or the cloud, as further described herein.

Having briefly described an overview of aspects of the technology described herein, an exemplary operating environment suitable for use in implementing the technology is described below.

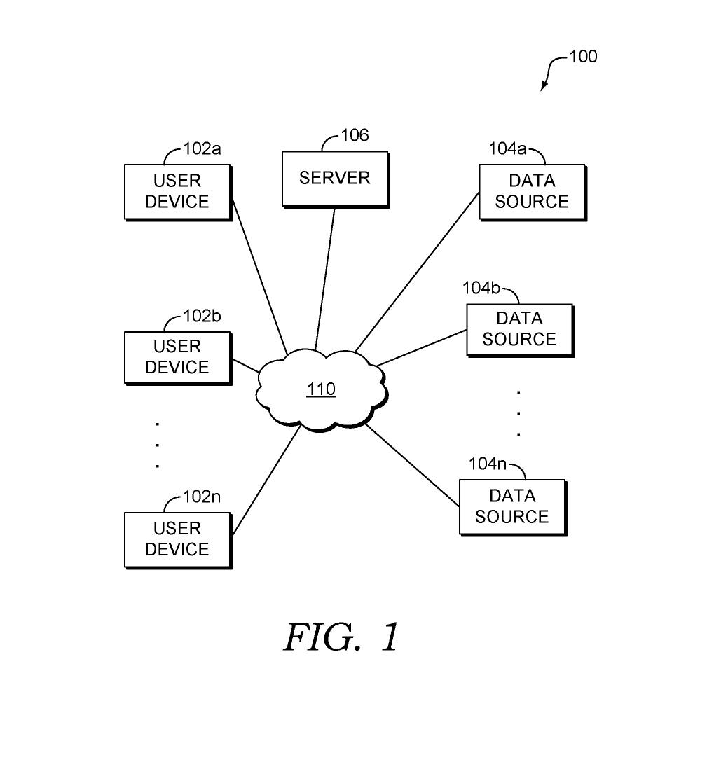

Turning now to FIG. 1, a block diagram is provided showing an example operating environment 100 in which some embodiments of the present disclosure may be employed. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether for the sake of clarity. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, some functions may be carried out by a processor executing instructions stored in memory.

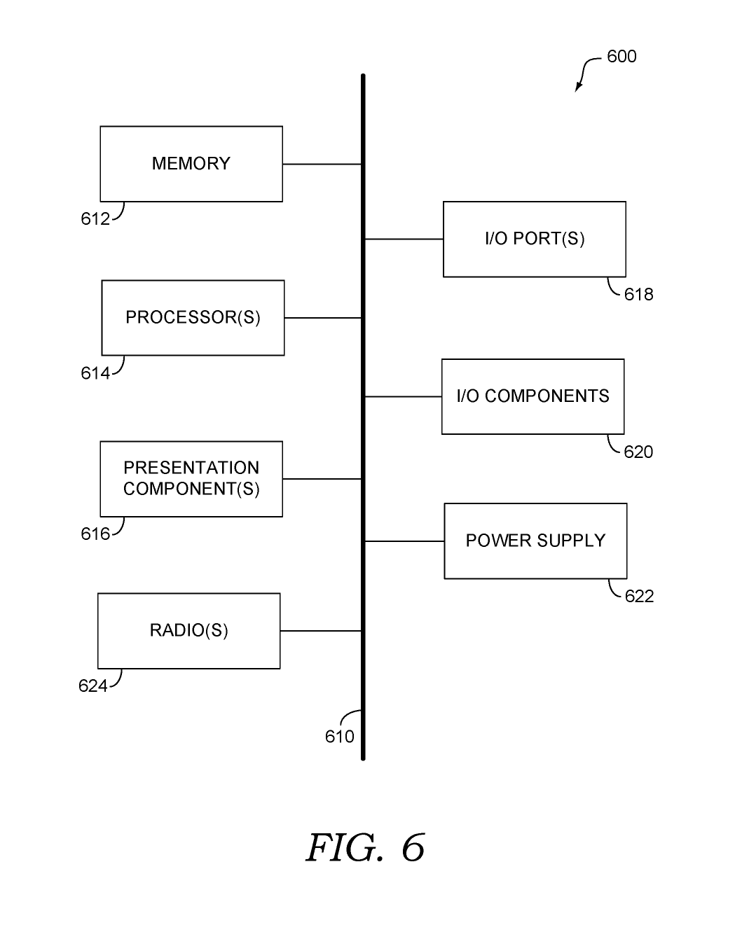

Among other components not shown, example operating environment 100 includes a number of user devices, such as user devices 102a and 102b through 102n; a number of data sources, such as data sources 104a and 104b through 104n; server 106; and network 110. It should be understood that environment 100 shown in FIG. 1 is an example of one suitable operating environment. Each of the components shown in FIG. 1 may be implemented via any type of computing device, such as computing device 600, described in connection to FIG. 6, for example. These components may communicate with each other via network 110, which may include, without limitation, one or more local area networks (LANs) and/or wide area networks (WANs). In exemplary implementations, network 110 comprises the Internet and/or a cellular network, amongst any of a variety of possible public and/or private networks.

It should be understood that any number of user devices, servers, and data sources may be employed within operating environment 100 within the scope of the present disclosure. Each may comprise a single device or multiple devices cooperating in a distributed environment. For instance, server 106 may be provided via multiple devices arranged in a distributed environment that collectively provide the functionality described herein. Additionally, other components not shown may also be included within the distributed environment.

User devices 102a and 102b through 102n can be client devices on the client-side of operating environment 100, while server 106 can be on the server-side of operating environment 100. Server 106 can comprise server-side software designed to work in conjunction with client-side software on user devices 102a and 102b through 102n so as to implement any combination of the features and functionalities discussed in the present disclosure. This division of operating environment 100 is provided to illustrate one example of a suitable environment, and there is no requirement for each implementation that any combination of server 106 and user devices 102a and 102b through 102n remain as separate entities.

User devices 102a and 102b through 102n may comprise any type of computing device capable of use by a user. For example, in one embodiment, user devices 102a through 102n may be the type of computing device described in relation to FIG. 6 herein. By way of example and not limitation, a user device may be embodied as a personal computer (PC), a laptop computer, a mobile or mobile device, a smartphone, a tablet computer, a smart watch, a wearable computer, a personal digital assistant (PDA), an MP3 player, global positioning system (GPS) or device, video player, handheld communications device, gaming device or system, entertainment system, vehicle computer system, embedded system controller, remote control, appliance, consumer electronic device, a workstation, or any combination of these delineated devices, or any other suitable device.

Data sources 104a and 104b through 104n may comprise data sources and/or data systems, which are configured to make data available to any of the various constituents of operating environment 100, or system 200 described in connection to FIG. 2. (For example, in one embodiment, one or more data sources 104a through 104n provide (or make available for accessing) user data to user-data collection component 214 of FIG. 2.) Data sources 104a and 104b through 104n may be discrete from user devices 102a and 102b through 102n and server 106 or may be incorporated and/or integrated into at least one of those components. In one embodiment, one or more of data sources 104a though 104n comprises one or more sensors, which may be integrated into or associated with one or more of the user device(s) 102a, 102b, or 102n or server 106. Examples of sensed user data made available by data sources 104a though 104n are described further in connection to user-data collection component 214 of FIG. 2

Operating environment 100 can be utilized to implement one or more of the components of system 200, described in FIG. 2, including components for collecting user data, monitoring events, generating captions, and/or presenting captions and related content to users. Referring now to FIG. 2, with FIG. 1, a block diagram is provided showing aspects of an example computing system architecture suitable for implementing an embodiment of the invention and designated generally as system 200. System 200 represents only one example of a suitable computing system architecture. Other arrangements and elements can be used in addition to or instead of those shown, and some elements may be omitted altogether for the sake of clarity. Further, as with operating environment 100, many of the elements described herein are functional entities that may be implemented as discrete or distributed components or in conjunction with other components, and in any suitable combination and location.

Example system 200 includes network 110, which is described in connection to FIG. 1, and which communicatively couples components of system 200 including user-data collection component 214, events monitor 280, caption engine 260, presentation component 218, and storage 225. Events monitor 280 (including its components 282, 284, 286, and 288), caption engine 260 (including its components 262, 264, 266, and 268), user-data collection component 214, and presentation component 218 may be embodied as a set of compiled computer instructions or functions, program modules, computer software services, or an arrangement of processes carried out on one or more computer systems, such as computing device 600 described in connection to FIG. 6, for example.

In one embodiment, the functions performed by components of system 200 are associated with one or more caption generation applications, personal assistant applications, services, or routines. In particular, such applications, services, or routines may operate on one or more user devices (such as user device 102a), servers (such as server 106), may be distributed across one or more user devices and servers, or be implemented in the cloud. Moreover, in some embodiments, these components of system 200 may be distributed across a network, including one or more servers (such as server 106) and client devices (such as user device 102a), in the cloud, or may reside on a user device, such as user device 102a. Moreover, these components, functions performed by these components, or services carried out by these components may be implemented at appropriate abstraction layer(s) such as the operating system layer, application layer, hardware layer, etc., of the computing system(s). Alternatively, or in addition, the functionality of these components and/or the embodiments described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. Additionally, although functionality is described herein with regards to specific components shown in example system 200, it is contemplated that in some embodiments functionality of these components can be shared or distributed across other components.

Continuing with FIG. 2, user-data collection component 214 is generally responsible for accessing or receiving (and in some cases also identifying) user data from one or more data sources, such as data sources 104a and 104b through 104n of FIG. 1. User data can include user-generated images and captions. In some embodiments, user-data collection component 214 may be employed to facilitate the accumulation of user data of one or more users (including crowd-sourced data) for events monitor 280 and caption engine 260. The data may be received (or accessed), and optionally accumulated, reformatted and/or combined, by user-data collection component 214 and stored in one or more data stores such as storage 225, where it may be available to events monitor 280 and caption engine 260. For example, the user data may be stored in or associated with a user profile 240, as described herein.

User data may be received from a variety of sources where the data may be available in a variety of formats. For example, in some embodiments, user data received via user-data collection component 214 may be determined via one or more sensors, which may be on or associated with one or more user devices (such as user device 102a), servers (such as server 106), and/or other computing devices. As used herein, a sensor may include a function, routine, component, or combination thereof for sensing, detecting, or otherwise obtaining information, such as user data from a data source 104a, and may be embodied as hardware, software, or both. By way of example and not limitation, user data may include data that is sensed or determined from one or more sensors (referred to herein as sensor data), such as location information of mobile device(s), smartphone data (such as phone state, charging data, date/time, or other information derived from a smartphone), user-activity information (for example: app usage; online activity; searches; voice data such as automatic speech recognition; activity logs; communications data including calls, texts, instant messages, and emails; website posts; other user-data associated with events; etc.) including user activity that occurs over more than one user device, user history, session logs, application data, contacts data, camera data, image store data, calendar and schedule data, notification data, social-network data, news (including popular or trending items on search engines or social networks, and social posts that include a visual media and/or link to visual media), online gaming data, ecommerce activity (including data from online accounts such as Amazon.com®, eBay®, PayPal®, or Xbox Live®), user-account(s) data (which may include data from user preferences or settings associated with a personal assistant application or service), home-sensor data, appliance data, global positioning system (GPS) data, vehicle signal data, traffic data, weather data (including forecasts), wearable device data, other user device data (which may include device settings, profiles, network connections such as Wi-Fi network data, or configuration data, data regarding the model number, firmware, or equipment, device pairings, such as where a user has a mobile phone paired with a Bluetooth headset, for example), gyroscope data, accelerometer data, payment or credit card usage data (which may include information from a user's PayPal account), purchase history data (such as information from a user's Amazon.com or eBay account), other sensor data that may be sensed or otherwise detected by a sensor (or other detector) component including data derived from a sensor component associated with the user (including location, motion, orientation, position, user-access, user-activity, network-access, user-device-charging, or other data that is capable of being provided by one or more sensor component), data derived based on other data (for example, location data that can be derived from Wi-Fi, Cellular network, or IP address data), and nearly any other source of data that may be sensed or determined as described herein. In some respects, user data may be provided in user signals. A user signal can be a feed of user data from a corresponding data source. For example, a user signal could be from a smartphone, a home-sensor device, a GPS device (e.g., for location coordinates), a vehicle-sensor device, a wearable device (e.g., exercise monitor), a user device, a gyroscope sensor, an accelerometer sensor, a calendar service, an email account, a credit card account, or other data sources. In some embodiments, user-data collection component 214 receives or accesses data continuously, periodically, or as needed.

Events monitor 280 is generally responsible for monitoring events and related information in order to determine event patterns, event response information, and contextual information associated with events. The technology describe herein can focus on events related to visual media. For example, as described previously, events and user interactions (e.g., generating media, sharing media, receiving media) with visual media associated with those events may be determined by monitoring user data (including data received from user-data collection component 214), and from this, event patterns related to visual images may be determined and detected. In some embodiments, events monitor 280 monitors events and related information across multiple computing devices or in the cloud.

As shown in example system 200, events monitor 280 comprises an event-pattern identifier 282, contextual-information extractor 286, and event-response analyzer 288. In some embodiments, events monitor 280 and/or one or more of its subcomponents may determine interpretive data from received user data. Interpretive data corresponds to data utilized by the subcomponents of events monitor 280 to interpret user data. For example, interpretive data can be used to provide context to user data, which can support determinations or inferences made by the subcomponents. Moreover, it is contemplated that embodiments of events monitor 280 and its subcomponents may use user data and/or user data in combination with interpretive data for carrying out the objectives of the subcomponents described herein.

Event-pattern identifier 282, in general, is responsible for determining event patterns where users interact with visual media. In some embodiments, event patterns may be determined by monitoring one or more variables related to events or user interactions with visual media before, during, or after those events. These monitored variables may be determined from the user data described in connection to user-data collection component 214 (for example: location, time/day, the initiator(s) or recipient(s) of a communication including a visual media, the communication type (e.g., social post, email, text, etc.), user device data, etc.). In particular, the variables may be determined from contextual data related to events, which may be extracted from the user data by contextual-information extractor 286, as described herein. Thus, the variables can represent context similarities among multiple events. In this way, patterns may be identified by detecting variables in common over multiple events. More specifically, variables associated with a first event may be correlated with variables of a second event to identify in-common variables for determining a likely pattern. For example, where a first event comprises a user posting a digital image of food with a caption from a restaurant on a first Saturday and a second event comprises user posting a digital image with a caption from a different restaurant on the following Saturday, a pattern may be determined that the user posts pictures taken in a restaurant on Saturday. In this case, the in-common variables for the two events include the same type of picture (of food), the same day (Saturday), with a caption, from the same class of location (restaurant), and the same type or mode of communication (a social post).

An identified pattern becomes stronger (i.e., more likely or more predictable) the more often the event instances that make up the pattern are repeated. Similarly, specific variables can become more strongly associated with a pattern as they are repeated. For example, suppose every day after 5 pm (after work) a user texts a picture taken during the day along with a caption to someone in the same group of contacts (which could be her family members). While the specific person texted varies (i.e., the contact-entity that the user texts), an event pattern exists because the user repeatedly texts someone in this group at about the same time each day.

Event patterns do not necessarily include the same communication modes. For instance, one pattern may be that a user texts or emails his mom a picture of his kids every Saturday. Moreover, in some instances, events pattern may evolve, such as where the user who texts his mom every Saturday starts to email his mom instead of texting her on some Saturdays, in which case the pattern becomes the user communicating with his mom on Saturdays. Event patterns may include event-related routines; typical user activity associated with events, or repeated event-related user activity that is associated with at least one in-common variable. Further, in some embodiments, event patterns can include user response patterns to receiving media, which may be determined from event-response analyzer 288, described below.

Event-response analyzer 288, in general, is responsible for determining response information for the monitored events, such as how users respond to receiving media associated with particular events and event response patterns. Response information is determined by analyzing user data (received from user-data collection component 214) corresponding to events and user activity that occurs after a user becomes aware of visual media associated with an event. In some embodiments, event-response analyzer 288 receives data from presentation component 218, which may include a user action corresponding to a monitored event, and/or receives contextual information about the monitored events from contextual-information extractor 286. Event-response analyzer 288 analyzes this information in conjunction with the monitored event and determines a set of response information for the event. For example, the user may immediately reply to or share media received when associated with a type of event. Based on response information determined over multiple events, event-response analyzer 288 can determine response patterns of particular users for media associated with certain events, based on contextual information associated with the event. For example, where monitored events include incoming visual media from a user's boss, event-response analyzer 288 may determine that the user responds to the visual media at the first available opportunity after the user becomes aware of the communication. But where the monitored event includes receiving a communication with a visual media from the user's wife, event-response analyzer 288 may determine that the user typically replies to her communication between 12 pm and 1 pm (i.e., at lunch) or after 5:30 pm (i.e., after work). Similarly, event-response analyzer 288 may determine that a user responds to certain events (which may be determined by contextual-information extractor 286 based on variables associated with the events) only under certain conditions, such as when the user is at home, at work, in the car, in front of a computer, etc. In this way, event-response analyzer 288 determines response information that incudes user response patterns for particular events and media received that relates to the events. The determined response patterns of a user may be stored in event response model(s) component 244 of a user profile 240 associated with the user, and may be used by caption engine 260 for generating captions for the user.

Further, in some embodiments, event-response analyzer 288 determines response information using crowdsourcing data or data from multiple users, which can be used for determining likely response patterns for a particular user based on the premise that the particular user will react similar to other users. For example, a user pattern may be determined based on determinations that other users are more likely to share visual media received from their friends and family members in the evenings but are less likely to share media received from these same entities during the day while at work.

Moreover, in some embodiments, contextual-information extractor 286 provides contextual information corresponding to similar events from other users, which may be used by event-response analyzer 288 to determine responses undertaken by those users. The contextual information can be used to generate caption text. Other users with similar events may be identified by determining context similarities, such as variables in the events of the other users that are in common with variables of the events of the particular user. For example, in-common variables could include the relationships between the parties (e.g., the relationship between the user and the recipient or initiator of a communication event that includes visual media), location, time, day, mode of communication, or any of the other variables described previously. Accordingly, event-response analyzer 288 can learn response patterns typical of a population of users based on crowd-sourced user information (e.g., user history, user activity following (and in some embodiments preceding) an associated event, relationship with contact-entities, and other contextual information) received from multiple users with similar events. Thus, from the response information, it may be determined what are the typical responses undertaken when an event having certain characteristics (e.g., context features or variables) occurs.

Moreover, most users behave or react differently to different contacts or entities. Events may be associated with an entity, with a class of entities (e.g., close friends, work colleagues, boss, family, businesses frequented by the user, such as a bank, etc.). Using contextual information provided by contextual-information extractor 286 (described below), event-response analyzer 288 may infer user response information for a user based on how that user responded to media received from similar classes of entities, or how other users responded in similar circumstances (such as where in-common variables are present). Thus, for example, where a particular user receives a visual media from a new social contact and has never responded to that social contact before, event-response analyzer 288 can consider how that user has previously responded to his other social contacts or how the user's social contacts (as other users in similar circumstances) have responded to that same social contact or other social contacts.

Contextual-information extractor 286, in general, is responsible for determining contextual information associated with the events monitored by events monitor 280, such as context features or variables associated with events and user-related activity, such as caption generation and media sharing. Contextual information may be determined from the user data of one or more users provided by user-data collection component 214. For example, contextual-information extractor 286 receives user data, parses the data, in some instances, and identifies and extracts context features or variables. In some embodiments, variables are stored as a related set of contextual information associated with an event, response, or user activity within a time interval following an event (which may be indicative of a user response).

In particular, some embodiments of contextual-information extractor 286 determine contextual information related to an event, contact-entity (or entities, such as in the case of a group email), user activity surrounding the event, and current user activity. By way of example and not limitation, this may include context features such as location data; time, day, and/or date; number and/or frequency of communications, frequency of media sharing and receiving; keywords in the communication (which may be used for generating captions); contextual information about the entity (such as the entity identity, relation with the user, location of the contacting entity if determinable, frequency or level of previous contact with the user); history information including patterns and history with the entity; mode or type of communication(s); what user activity the user engages in when an event occurs or when likely responding to an event, as well as when, where, and how often the user views, shares, or generates media associated with the event; or any other variables determinable from the user data, including user data from other users.

As described above, the contextual information may be provided to: event-pattern identifier 282 for determining patterns (such as event patterns using in-common variables); and event-response analyzer 288 for determining response patterns (including response patterns of other users). In particular, contextual information provided to event-response analyzer 288 may be used for determining information about user response patterns when media is generated or received, user-activities that may correspond to responding to an unaddressed event, how long a user engages in responding to the unaddressed event, modes of communication, or other information for determining user capabilities for sharing or receiving media associated with an event.

Continuing with FIG. 2, caption engine 260 is generally responsible for generating and providing captions for a visual media, such as a picture or video. In some cases, the caption engine uses caption logic specifying conditions for generating the caption based on user data, such as time(s), location(s), mode(s), or other parameters relating to an visual media.

In some embodiments, caption engine 260 generates a caption to be presented to a user, which may be provided to presentation component 218. Alternatively, in other embodiments, caption engine 260 generates a caption and makes it available to presentation component 218, which determines when and how (i.e., what format) to present the caption based on caption logic and user data applied to the caption logic.

As described previously, caption engine 260 may receive information from user-data collection component 214 and/or events monitor 280 (which may be stored in a user profile 240 that is associated with the user) including event data; image data, current user information, such as user activity; contextual information; response information determined from event-response analyzer 288 (including in some instances how other users respond or react to similar events and image combinations); event pattern information; or information from other components or sources used for creating caption content.

As shown in example system 200, caption engine 260 comprises an image classifier 262, context extractor 264, caption-scenario component 266, and caption generator 268. The caption engine 260 generates the caption using data from the image in combination with signal data received from a mobile device on which the visual media is present. Using both image data and signal data may be referred to as multi-modal caption generation. The data from the image could be metadata associated with the image or gathered via object identification performed on the image, for example by the image classifier 262. For example, people, places, and objects can be recognized in the image.

In one aspect, the image classifier 262 receives an image. The image may be an active image displayed in an image application or other application on the user device. In one aspect, the image is specifically sent to a captioning application by the user or a captioning application is explicitly invoked in conjunction with an active image. In another aspect, captions are automatically generated without a user request, for example, by a personal assistant application.

In one aspect, the user selects a portion of the image that is associated with a recognizable object. The portion of the image may be selected prior to recognition of an object in the image by the image classifier 262. Alternatively, objects that are recognizable within the image could be highlighted or annotated within the image for user selection. For example, an image of multiple people could have individual faces annotated with a selection interface. The user could then select one of the faces for caption generation. The user may select a portion of the image by placing their finger on a portion of the image, by lassoing part of the image by drawing a circle with their finger or a stylus, or through some other mechanism.

In one aspect, a selection interface is only presented when multiple scenario-linked objects are present in the image. Scenario-linked objects are those tied to a caption scenario. For example, a picture could depict a dog and a park bench. If the dog is tied to caption scenario and the park bench is not, then the dog is a scenario-linked object and the park bench is not.

A selected object may be assigned an object classification using an image classifier. An image classifier may comprise a database of images along with human annotation data identifying objects depicted in the images. The database of images are then used to train a classifier that can receive unmarked images to an identify objects in the images. For example, a collection of images of shoes could be used to identify a shoe in an unmarked image through an image analysis that looks for similarity between the images.

The image classifier 262 may use various combinations of features to generate a feature vector for classifying objects within images. The classification system may use both the ranked prevalent color histogram feature and the ranked region size feature. In addition, the classification system may use a color moment feature, a correlograms feature, and a farthest neighbor histogram feature. The color moment feature characterizes the color distribution using color moments such as mean, standard deviation, and skewness for the H, S, and V channels of HSV space. The correlograms feature incorporates the spatial correlation of colors to provide texture information and describes the global distribution of the local spatial correlation of colors. The classification system may simplify the process of extracting the correlograms features by quantizing the RGB colors and using the probability that the neighbors of a given pixel are identical in color as the feature. The farthest neighbor histogram feature identifies the pattern of color transitions from pixel to pixel. The classification system may combine various combinations of features into the feature vector that is used to classify an object within an image.

In one embodiment, image classifier 262 trains a classifier based on image training data. The training data can comprise images that include one or more objects with the objects labeled. The classification system generates a feature vector for each image of the training data. The feature vector may include various combinations of the features included in the ranked prevalent color histogram feature and the ranked region size feature. The classification system then trains the classifier using the feature vectors and classifications of the training images. The image classifier 262 may use various classifiers. For example, the classification system may use a support vector machine (“SVM”) classifier, an adaptive boosting (“AdaBoost”) classifier, a neural network model classifier, and so on.

The context extractor 264 can use signal data from a computing device to determine a context for the image. For example, the signal data could be GPS data indicating that the user was in a particular location corresponding to a restaurant when the image was taken. The signal data can also help identify other events that are associated with the image, for example, that the user is on vacation, just exercised, etc. The caption is built using information from both the picture and context.

The signal data gathered by a computing device can be mined to extract event information. Event information describes an event the user has or will participate in. For example, an exercise event could be detected in temporal proximity to taking a picture. In combination with an image of nachos, a caption could be generated stating “nothing beats a plate of nachos after a five-mile run.” The nachos could be identified through image analysis of an active photograph being viewed by the user. The running event and distance of the run could be extracted from event information. For example, the mobile device could include an exercise tracker or be linked to a separate exercise tracker that provides information about heart rate and distance traveled to the mobile device. The mobile device could look at the exercise data and associate it with an event consistent with an exercise pattern, such as a five-mile run.

The technology described herein can then analyze signal data from the mobile device to match the signal data to an event. Different events can be associated with different signal data. For example, a travel event could be associated with GPS and accelerometer data indicating a distance and velocity traveled that is consistent with a car, a bike, public transportation, or some other method. An exercise event could be associated with physiological data associated with exercise. A purchase event could be associated with web browsing activity and/or credit card activity indicating a purchase. A shopping event could be associated with the mobile device being located in a particular store or shopping area. An entertainment event could be associated with being located in an entertainment district. Other events and event classifications can be derived from signal data. Once an event is detected, semantic knowledge about the user can be mined to find additional information about the event. For example, consider a picture of a girl in a soccer uniform. The knowledge base could be mined to identify the name of the girl, for example, she may be the daughter of a person viewing the picture. Other information in the sematic knowledge base could include a park at which the soccer game is played, and perhaps other information derived from the user's social network, such as a team name. Information from pervious user-generated captions in the user's social network could be mined and the data extruded could be stored in the sematic knowledge base. A similarity analysis between a current picture and previously posted pictures could be used to help generate a caption.

The caption-scenario component 266 can map image data and context data to a caption scenario. The caption could be generated by first identifying a caption scenario that is mapped to both an image and an event. For example, a scenario could include an image of food in combination with an exercise event. Further analysis or classification could occur based on whether the food is classified as healthy or indulgent. If healthy, one or more caption templates associated with the consumption of healthy food in conjunction with exercise could be selected. The caption templates could include insertion points where details about the exercise event can be inserted, as well as a description of the food.

The object classification derived from the image along with event data derived from the signal data are used in combination to identify a caption scenario and ultimately generate a caption. In one aspect, the caption scenario is a heuristic or rule-based system that includes image classifications and event details that maps both to a scenario. In addition to object data and event details, user data can also be associated with a particular scenario. For example, the age of the user or other demographic information could be used to select a particular scenario. Alternatively, the age or demographic information could be used to select one of multiple caption templates within the scenario. For example, some caption scenarios may be written in slang used by a ten-year-old while another group of caption templates are more appropriate for an adult.

In one aspect, a user's previous use of suggested captions is tracked and the suggested caption is selected according to a rule that distributes the selection of captions in a way that the same caption is not selected for consecutive pictures.

The caption template can include text describing the scenario along with one or more insertion points. The insertion points receive text associated with the event and/or the object. In combination, the text and object or event data can form a phrase describing or related to the image.

The caption is then presented to the user. In one aspect, the caption is presented to the user as an overlay over the image. The overlay can take many different forms. In one aspect, the overlay takes the form of a textbox, as might be shown in a cartoon. Other forms are possible. The caption can also be inserted as text in a communication, such as a social post, email, or text message.

In one aspect, the user may adopt or edit the caption. The user can use a text editor to modify the caption prior to saving. If adopted, the caption can be associated with the image by forming an embedded overlay or as metadata associated with the image. The image, along with the overlay information, can then be communicated to one or more recipients designated by the user. For example, the user may choose to post the image and associated caption on one or more social networks. Alternatively, the user could communicate the image to a designated group of persons via text, email, or through some other communication mechanism. Finally, the user could choose to save the picture for later use in their photo album along with the associated caption.

Continuing with FIG. 2, some embodiments of events monitor 280 and caption engine 260 use statistics and machine learning techniques. In particular, such techniques may be used to determine pattern information associated with a user, such as event patterns, caption generation patterns, image sharing patterns, user response patterns, certain types of events, user preferences, user availability, and other caption content. For example, using crowd-sourced data, embodiments of the invention can learn to associate keywords or other context features (such as the relation between the contacting entity and user) and use this information to generate captions. In one embodiment, pattern recognition, fuzzy logic, clustering, or similar statistics and machine learning techniques are applied to identify caption use and image sharing patterns.

Example system 200 also includes a presentation component 218 that is generally responsible for presenting captions and related content to a user. Presentation component 218 may comprise one or more applications or services on a user device, across multiple user devices, or in the cloud. For example, in one embodiment, presentation component 218 manages the presentation of captions to a user across multiple user devices associated with that user. Based on caption logic and user data, presentation component 218 may determine on which user device(s) a caption is presented, as well as the context of the presentation, including how (or in what format and how much content, which can be dependent on the user device or context) it is presented, when it is presented, and what supplemental content is presented with it. In particular, in some embodiments, presentation component 218 applies caption logic to sensed user data and contextual information in order to manage the presentation of caption.

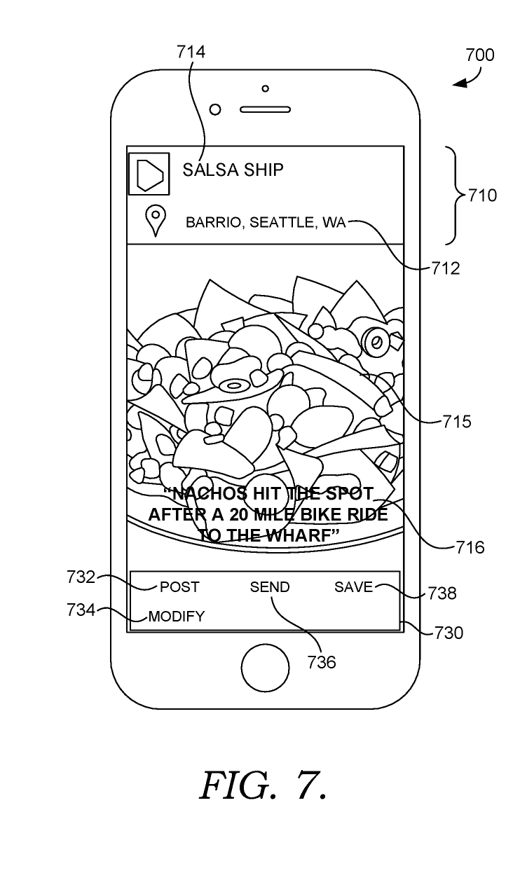

The presentation component can present the overlay with the image, as shown in FIG. 7. FIG. 7 shows a mobile device 700 displaying an image 715 of nachos with an automatically generated overlay 716. The overlay 716 states, “nachos hit the spot after a 20 mile bike ride to the wharf.” FIG. 7 also includes an information view 710. The information view 710 includes the name of a restaurant 714 at which the mobile device 700 is located. The fictional restaurant is called The Salsa Ship. The city and state 712 are also provided. The location of the mobile device may be derived from GPS data, Wi-Fi signals, or other signal input.

An action interface 730 provides functional buttons through which a user instructs the mobile device to take various actions. Selecting the post interface 732 causes the image and associated caption to be posted to a social media platform. The user can select a default platform or be given the opportunity to select one or more social media platforms through a separate interface (not shown in FIG. 7) upon selecting the post interface 732. The send interface 736 can open an interface through which the image and associated caption can be sent to one or more recipients through email, text, or some other communication method.

The user may be allowed to provide instructions regarding which recipients should receive the communication. Some recipients can automatically be selected based on previous image communication patterns derived from event data. For example, if a user emails the same group of people a picture of food when they are in a restaurant, then the same group of people could be inserted as an initial group upon the user pushing the send interface 736 when an image of food is shown in the user is in a restaurant. The save interface 738 allows the user to save the image and the caption. The modify interface 734 allows the user to modify the caption. Modifying the caption can include changing the font, font color, font size, and the actual text.

As mentioned, the caption in the overlay 716 can be generated by taking a default caption associated with a caption scenario and inserting details derived from the context of the image 715, the mobile device 700, and the user. In this example, a default caption could state, “<Insert Food object> hits the spot after a <insert exercise description>.” In this example, nachos could be the identified food object identified through image analysis.

The exercise description can be generated using default exercise description templates. For example, an exercise template for state “<insert a distance> run” for a run, “<insert a distance> bike to <insert a destination>.” In this example, 20 miles could be determined by analyzing location data for a mobile device and the location “the wharf” could also be identified using location data from the phone. The pace of movement could be used to distinguish a bike ride from a run. In an aspect, each scenario has a triggering criteria that is used to determine whether the scenario applied and each insertion within a given scenario can require additional determinations.

In some embodiments, presentation component 218 generates user interface features associated with a caption. Such features can include interface elements (such as graphics buttons, sliders, menus, audio prompts, alerts, alarms, vibrations, pop-up windows, notification-bar or status-bar items, in-app notifications, or other similar features for interfacing with a user), queries, and prompts. For example, presentation component 218 may query the user regarding user preferences for captions, such as asking the user “Keep showing you similar captions in the future?” or “Please rate the accuracy of this caption from 1-5 . . . .” Some embodiments of presentation component 218 capture user responses (e.g., modifications) to captions or user activity associated with captions (e.g., sharing, saving, dismissing, deleting).

As described previously, in some embodiments, a personal assistant service or application operating in conjunction with presentation component 218 determines when and how to present the caption. In such embodiments, the caption content may be understood as a recommendation to the presentation component 218 (and/or personal assistant service or application) for when and how to present the caption, which may be overridden by the personal assistant app or presentation component 218.

Example system 200 also includes storage 225. Storage 225 generally stores information including data, computer instructions (e.g., software program instructions, routines, or services), and/or models used in embodiments of the technology described herein. In an embodiment, storage 225 comprises a data store (or computer data memory). Further, although depicted as a single data store component, storage 225 may be embodied as one or more data stores or may be in the cloud. The storage 225 can include a photo album and a caption log that stores previously generated captions.

In an embodiment, storage 225 stores one or more user profiles 240, an example embodiment of which is illustratively provided in FIG. 2. Example user profile 240 may include information associated with a particular user or, in some instances, a category of users. As shown, user profile 240 includes event(s) data 242, event pattern(s) 243, event response model(s) 244, caption model(s) 246, user account(s) and activity data 248, and captions(s) 250. The information stored in user profiles 240 may be available to the routines or other components of example system 200.

Event(s) data 242 generally includes information related to events associated with a user, and may include information about events determined by events monitor 280, contextual information, and may also include crowd-sourced data. Event pattern(s) 243 generally includes information about determined event patterns associated with the user; for example, a pattern indicating that the user posts an image and a caption when at a sporting event. Information stored in event pattern(s) 243 may be determined from event-pattern identifier 282. Event response model(s) 244 generally includes response information determined by event-response analyzer 288 regarding how the particular user (or similar users) respond to events. As described in connection to event-response analyzer 288, in some embodiments, one or more response models may be determined Response models may be based on rules or settings, types or categories of events, context features or variables (such as relation between a contact-entity and the user), and may be learned, such as from user history like previous user responses and/or responses from other users.

User account(s) and activity data 248 generally includes user data collected from user-data collection component 214 (which in some cases may include crowd-sourced data that is relevant to the particular user) or other semantic knowledge about the user. In particular, user account(s) and activity data 248 can include data regarding user emails, texts, instant messages, calls, and other communications; social network accounts and data, such as news feeds; online activity; calendars, appointments, or other user data that may have relevance for generating captions; user availability. Embodiments of user account(s) and activity data 248 may store information across one or more databases, knowledge graphs, or data structures.

Captions(s) 250 generally include data about captions associated with a user, which may include caption content corresponding to one or more visual media. The captions can be generated by the technology described herein, by the user, or by a person that communicates the caption with the user.

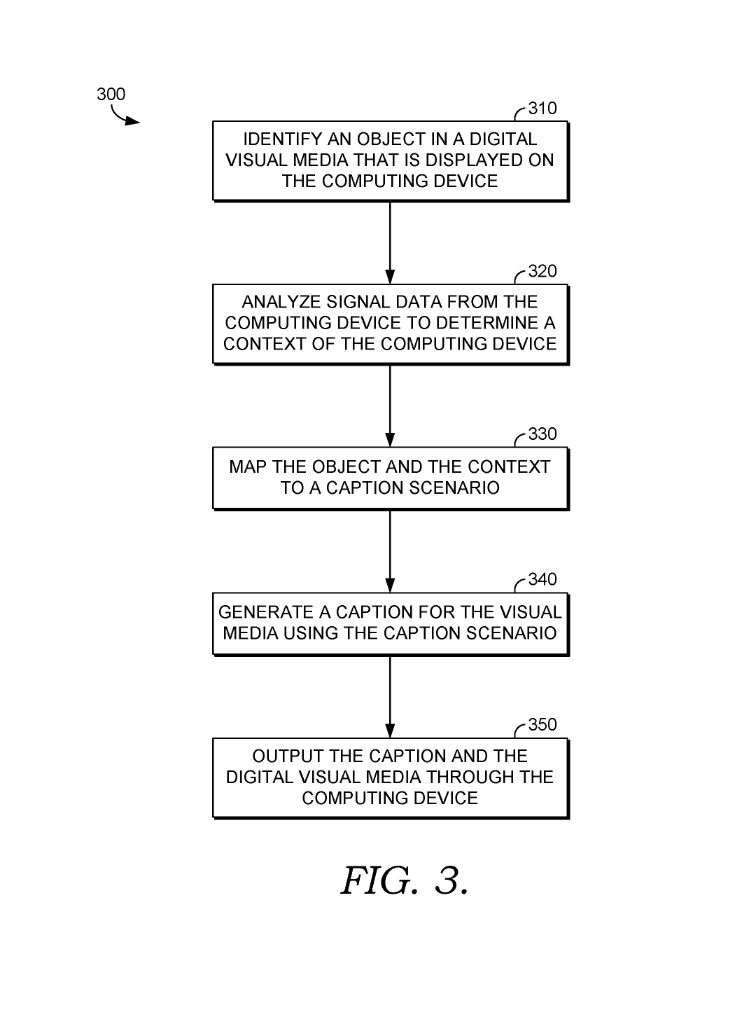

Turning now to FIG. 3, a method 300 of generating captions is provided, according to an aspect of the technology described herein. Method 300 could be performed by a user device, such as a laptop or smart phone, in a data center, or in a distributed computing environment including user devices and data centers.

At step 310 an object is identified in a visual media that is displayed on a computing device, such as a mobile phone. Identifying the object can comprise classifying the object into a known category, such as a person, a dog, a cat, a plate of food, or birthday hat. The classification can occur at different levels of granularity, for example, a specific person or location could be identified. In one aspect, the user selects a portion of the image that is associated with the object so the object can be identified. The portion of the image may be selected prior to recognition of an object in the image by. Alternatively, objects that are recognizable within the image could be highlighted or annotated within the image for user selection. For example, an image of multiple people could have individual faces annotated with a selection interface. The user could then select one of the faces for caption generation. The user may select a portion of the image by placing their finger on a portion of the image, by lassoing part of the image by drawing a circle with their finger or a stylus, or through some other mechanism.

In one aspect, a selection interface is only presented when multiple scenario-linked objects are present in the image. Scenario-linked objects are those tied to a caption scenario. For example, a picture could depict a dog and a park bench. If the dog is tied to caption scenario and the park bench is not, then the dog is a scenario-linked object and the park bench is not.

A selected object may be assigned an object classification using an image classifier. An image classifier may comprise a database of images along with human annotation data identifying objects depicted in the images. The database of images are then used to train a classifier that can receive unmarked images to an identify objects in the images. For example, a collection of images of shoes could be used to identify a shoe in an unmarked image through an image analysis that looks for similarity between the images.

Various combinations of features can be used to generate a feature vector for classifying objects within images. The classification system may use both the ranked prevalent color histogram feature and the ranked region size feature. In addition, the classification system may use a color moment feature, a correlograms feature, and a farthest neighbor histogram feature. The color moment feature characterizes the color distribution using color moments such as mean, standard deviation, and skewness for the H, S, and V channels of HSV space. The correlograms feature incorporates the spatial correlation of colors to provide texture information and describes the global distribution of the local spatial correlation of colors. The classification system may simplify the process of extracting the correlograms features by quantizing the RGB colors and using the probability that the neighbors of a given pixel are identical in color as the feature. The farthest neighbor histogram feature identifies the pattern of color transitions from pixel to pixel. The classification system may combine various combinations of features into the feature vector that is used to classify an object within an image.

In one embodiment, a classifier is trained using image training data that comprises images that include one or more objects with the objects labeled. The classification system generates a feature vector for each image of the training data. The feature vector may include various combinations of the features included in the ranked prevalent color histogram feature and the ranked region size feature. The classification system then trains the classifier using the feature vectors and classifications of the training images. The image classifier 262 may use various classifiers. For example, the classification system may use a support vector machine (“SVM”) classifier, an adaptive boosting (“AdaBoost”) classifier, a neural network model classifier, and so on.

At step 320, signal data from the computing device is analyzed to determine a context of the visual media. Exemplary signal data has been described previously. The context of the visual media can be derived from the context of the computing device at the time a visual media was created by the computing device. The context of the image can include the location of the computing device when the visual media is generated. The context of the image can also include recent events detected within a threshold period of time from when the visual media is generated. The context can include detecting recently completed events or upcoming events as described previously.

At step 330 the object and the context are mapped to a caption scenario. The caption could be generated by first identifying a caption scenario that is mapped to both an image and an event. For example, a scenario could include an image of food in combination with an exercise event. Further analysis or classification could occur based on whether the food is classified as healthy or indulgent. If healthy, one or more caption templates associated with the consumption of healthy food in conjunction with exercise could be selected. The caption templates could include insertion points where details about the exercise event can be inserted, as well as a description of the food.

The object classification derived from the image along with event data derived from the signal data are used in combination to identify a caption scenario and ultimately generate a caption. In one aspect, the caption scenario is a heuristic or rule-based system that includes image classifications and event details that maps both to a scenario. In addition to object data and event details, user data can also be associated with a particular scenario. For example, the age of the user or other demographic information could be used to select a particular scenario. Alternatively, the age or demographic information could be used to select one of multiple caption templates within the scenario. For example, some caption scenarios may be written in slang used by a ten-year-old while another group of caption templates are more appropriate for an adult.

In one aspect, a user's previous use of suggested captions is tracked and the suggested caption is selected according to a rule that distributes the selection of captions in a way that the same caption is not selected for consecutive pictures.

At step 340 a caption for the visual media is generated using the caption scenario. The caption template can include text describing the scenario along with one or more insertion points. The insertion points receive text associated with the event and/or the object. In combination, the text and object or event data can form a phrase describing or related to the image.

As mentioned, the caption can be generated by taking a default caption associated with a caption scenario and inserting details derived from the context of the visual media, the computing device, and the user. In this example, a default caption could state, “<Insert Food object> hits the spot after a <insert exercise description>.” In this example, nachos could be the identified food object identified through image analysis.

The exercise description can be generated using default exercise description templates. For example, an exercise template for state “<insert a distance> run” for a run, “<insert a distance> bike to <insert a destination>.” In this example, 20 miles could be determined by analyzing location data for a mobile device and the location “the wharf” could also be identified using location data from the phone. The pace of movement could be used to distinguish a bike ride from a run. In an aspect, each scenario has a triggering criteria that is used to determine whether the scenario applied and each insertion within a given scenario can require additional determinations.

At step 350 the caption and the visual media are output for display through the computing device. In one aspect, the caption is presented to the user as an overlay over the image. The overlay can take many different forms. In one aspect, the overlay takes the form of a textbox, as might be shown in a cartoon. Other forms are possible. The caption can also be inserted as text in a communication, such as a social post, email, or text message.

In one aspect, the user may adopt or edit the caption. The user can use a text editor to modify the caption prior to saving. If adopted, the caption can be associated with the image by forming an embedded overlay or as metadata associated with the image. The image, along with the overlay information, can then be communicated to one or more recipients designated by the user. For example, the user may choose to post the image and associated caption on one or more social networks. Alternatively, the user could communicate the image to a designated group of persons via text, email, or through some other communication mechanism. Finally, the user could choose to save the picture for later use in their photo album along with the associated caption.

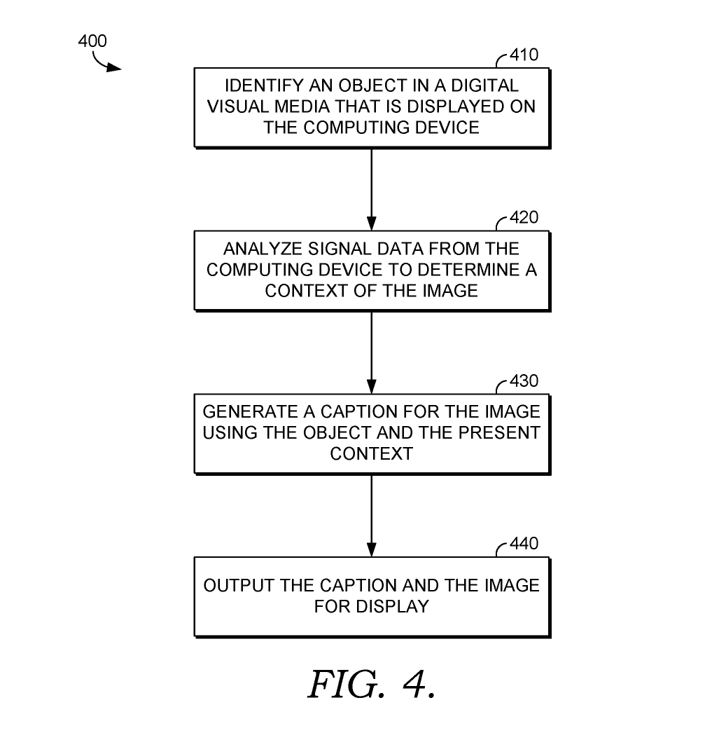

Turning now to FIG. 4, a method 400 for generating a caption is provided, according to an aspect the technology described herein. Method 400 could be performed by a user device, such as a laptop or smart phone, in a data center, or in a distributed computing environment including user devices and data centers.

At step 410 an object in a visual media is identified. The visual media is displayed on a computing device. Identifying the object can comprise classifying the object into a known category, such as a person, a dog, a cat, a plate of food, or birthday hat. The classification can occur at different levels of granularity, for example, a specific person or location could be identified. In one aspect, the user selects a portion of the image that is associated with the object so the object can be identified. The portion of the image may be selected prior to recognition of an object in the image by. Alternatively, objects that are recognizable within the image could be highlighted or annotated within the image for user selection. For example, an image of multiple people could have individual faces annotated with a selection interface. The user could then select one of the faces for caption generation. The user may select a portion of the image by placing their finger on a portion of the image, by lassoing part of the image by drawing a circle with their finger or a stylus, or through some other mechanism.

In one aspect, a selection interface is only presented when multiple scenario-linked objects are present in the image. Scenario-linked objects are those tied to a caption scenario. For example, a picture could depict a dog and a park bench. If the dog is tied to caption scenario and the park bench is not, then the dog is a scenario-linked object and the park bench is not.

A selected object may be assigned an object classification using an image classifier. An image classifier may comprise a database of images along with human annotation data identifying objects depicted in the images. The database of images are then used to train a classifier that can receive unmarked images to an identify objects in the images. For example, a collection of images of shoes could be used to identify a shoe in an unmarked image through an image analysis that looks for similarity between the images.

Various combinations of features can be used to generate a feature vector for classifying objects within images. The classification system may use both the ranked prevalent color histogram feature and the ranked region size feature. In addition, the classification system may use a color moment feature, a correlograms feature, and a farthest neighbor histogram feature. The color moment feature characterizes the color distribution using color moments such as mean, standard deviation, and skewness for the H, S, and V channels of HSV space. The correlograms feature incorporates the spatial correlation of colors to provide texture information and describes the global distribution of the local spatial correlation of colors. The classification system may simplify the process of extracting the correlograms features by quantizing the RGB colors and using the probability that the neighbors of a given pixel are identical in color as the feature. The farthest neighbor histogram feature identifies the pattern of color transitions from pixel to pixel. The classification system may combine various combinations of features into the feature vector that is used to classify an object within an image.

In one embodiment, a classifier is trained using image training data that comprises images that include one or more objects with the objects labeled. The classification system generates a feature vector for each image of the training data. The feature vector may include various combinations of the features included in the ranked prevalent color histogram feature and the ranked region size feature. The classification system then trains the classifier using the feature vectors and classifications of the training images. The image classifier 262 may use various classifiers. For example, the classification system may use a support vector machine (“SVM”) classifier, an adaptive boosting (“AdaBoost”) classifier, a neural network model classifier, and so on.

At step 420 signal data from the computing device is analyzed to determine a context of the computing device. signal data from the computing device is analyzed to determine a context of the computing device. Exemplary signal data has been described previously. The context of the image can also include recent events detected within a threshold period of time from when the visual media is displayed. The context can include detecting recently completed events or upcoming events as described previously.

At step 430 a caption for the visual media is generated using the object and the context. The caption template can include text describing the scenario along with one or more insertion points. The insertion points receive text associated with the event and/or the object. In combination, the text and object or event data can form a phrase describing or related to the image.

As mentioned, the caption can be generated by taking a default caption associated with a caption scenario and inserting details derived from the context of the visual media, the computing device, and the user. In this example, a default caption could state, “<Insert Food object> hits the spot after a <insert exercise description>.” In this example, nachos could be the identified food object identified through image analysis.

The exercise description can be generated using default exercise description templates. For example, an exercise template for state “<insert a distance> run” for a run, “<insert a distance> bike to <insert a destination>.” In this example, 20 miles could be determined by analyzing location data for a mobile device and the location “the wharf” could also be identified using location data from the phone. The pace of movement could be used to distinguish a bike ride from a run. In an aspect, each scenario has a triggering criteria that is used to determine whether the scenario applied and each insertion within a given scenario can require additional determinations.

At step 440, the caption and the visual media are output for display. In one aspect, the caption is presented to the user as an overlay over the image. The overlay can take many different forms. In one aspect, the overlay takes the form of a textbox, as might be shown in a cartoon. Other forms are possible. The caption can also be inserted as text in a communication, such as a social post, email, or text message.

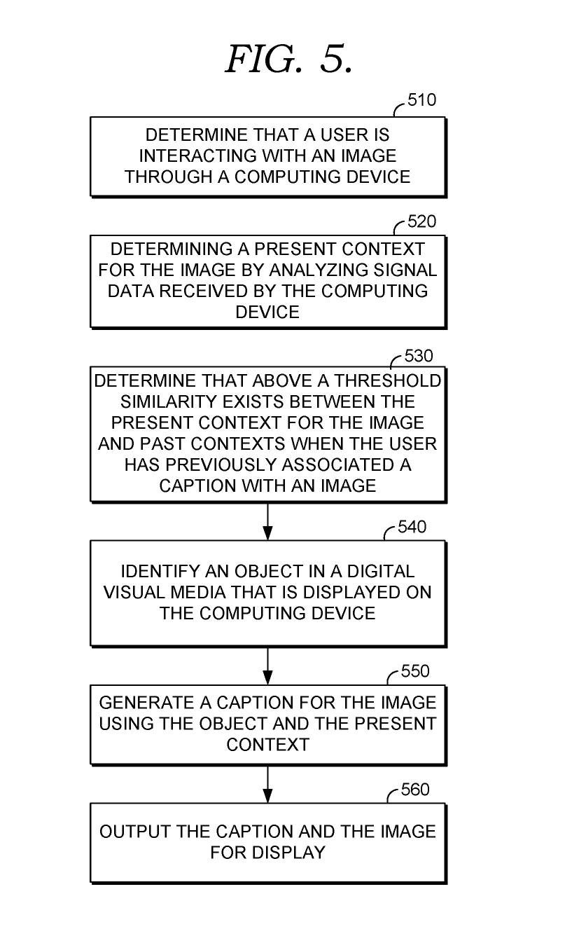

Turning now to FIG. 5, a method 500 for generating a caption is provided, according to an aspect the technology described herein. Method 400 could be performed by a user device, such as a laptop or smart phone, in a data center, or in a distributed computing environment including user devices and data centers.

At step 510, a user is determined to be interacting with an image through a computing device. Interacting with an image can include viewing an image, editing an image, attaching/embedding an image to an email or text, and such.

At step 520 a present context for the image is determined by analyzing signal data received by the computing device. Exemplary signal data has been described previously. The context of the visual media can be derived from the context of the computing device at the time a visual media was created by the computing device. The context of the image can include the location of the computing device when the visual media is generated. The context of the image can also include recent events detected within a threshold period of time from when the visual media is generated. The context can include detecting recently completed events or upcoming events as described previously.

At step 530, above a threshold similarity is determined to exist between the present context for the image and past contexts when the user has previously associated a caption with an image.

At step 540, an object in the image is identified. Identifying the object can comprise classifying the object into a known category, such as a person, a dog, a cat, a plate of food, or birthday hat. The classification can occur at different levels of granularity, for example, a specific person or location could be identified. In one aspect, the user selects a portion of the image that is associated with the object so the object can be identified. The portion of the image may be selected prior to recognition of an object in the image by. Alternatively, objects that are recognizable within the image could be highlighted or annotated within the image for user selection. For example, an image of multiple people could have individual faces annotated with a selection interface. The user could then select one of the faces for caption generation. The user may select a portion of the image by placing their finger on a portion of the image, by lassoing part of the image by drawing a circle with their finger or a stylus, or through some other mechanism.

In one aspect, a selection interface is only presented when multiple scenario-linked objects are present in the image. Scenario-linked objects are those tied to a caption scenario. For example, a picture could depict a dog and a park bench. If the dog is tied to caption scenario and the park bench is not, then the dog is a scenario-linked object and the park bench is not.

A selected object may be assigned an object classification using an image classifier. An image classifier may comprise a database of images along with human annotation data identifying objects depicted in the images. The database of images are then used to train a classifier that can receive unmarked images to an identify objects in the images. For example, a collection of images of shoes could be used to identify a shoe in an unmarked image through an image analysis that looks for similarity between the images.

Various combinations of features can be used to generate a feature vector for classifying objects within images. The classification system may use both the ranked prevalent color histogram feature and the ranked region size feature. In addition, the classification system may use a color moment feature, a correlograms feature, and a farthest neighbor histogram feature. The color moment feature characterizes the color distribution using color moments such as mean, standard deviation, and skewness for the H, S, and V channels of HSV space. The correlograms feature incorporates the spatial correlation of colors to provide texture information and describes the global distribution of the local spatial correlation of colors. The classification system may simplify the process of extracting the correlograms features by quantizing the RGB colors and using the probability that the neighbors of a given pixel are identical in color as the feature. The farthest neighbor histogram feature identifies the pattern of color transitions from pixel to pixel. The classification system may combine various combinations of features into the feature vector that is used to classify an object within an image.

In one embodiment, a classifier is trained using image training data that comprises images that include one or more objects with the objects labeled. The classification system generates a feature vector for each image of the training data. The feature vector may include various combinations of the features included in the ranked prevalent color histogram feature and the ranked region size feature. The classification system then trains the classifier using the feature vectors and classifications of the training images. The image classifier 262 may use various classifiers. For example, the classification system may use a support vector machine (“SVM”) classifier, an adaptive boosting (“AdaBoost”) classifier, a neural network model classifier, and so on.

At step 550, a caption for the image is generated using the object and the present context. The caption template can include text describing the scenario along with one or more insertion points. The insertion points receive text associated with the event and/or the object. In combination, the text and object or event data can form a phrase describing or related to the image.

As mentioned, the caption can be generated by taking a default caption associated with a caption scenario and inserting details derived from the context of the visual media, the computing device, and the user. In this example, a default caption could state, “<Insert Food object> hits the spot after a <insert exercise description>.” In this example, nachos could be the identified food object identified through image analysis.

The exercise description can be generated using default exercise description templates. For example, an exercise template for state “<insert a distance> run” for a run, “<insert a distance> bike to <insert a destination>.” In this example, 20 miles could be determined by analyzing location data for a mobile device and the location “the wharf” could also be identified using location data from the phone. The pace of movement could be used to distinguish a bike ride from a run. In an aspect, each scenario has a triggering criteria that is used to determine whether the scenario applied and each insertion within a given scenario can require additional determinations.

At step 560, the caption is output for display. In one aspect, the caption is presented to the user as an overlay over the image. The overlay can take many different forms. In one aspect, the overlay takes the form of a textbox, as might be shown in a cartoon. Other forms are possible. The caption can also be inserted as text in a communication, such as a social post, email, or text message.

### Exemplary Operating Environment

Referring to the drawings in general, and initially to FIG. 6 in particular, an exemplary operating environment for implementing aspects of the technology described herein is shown and designated generally as computing device 600. Computing device 600 is but one example of a suitable computing environment and is not intended to suggest any limitation as to the scope of use of the technology described herein. Neither should the computing device 600 be interpreted as having any dependency or requirement relating to any one or combination of components illustrated.

The technology described herein may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. The technology described herein may be practiced in a variety of system configurations, including handheld devices, consumer electronics, general-purpose computers, specialty computing devices, etc. Aspects of the technology described herein may also be practiced in distributed computing environments where tasks are performed by remote-processing devices that are linked through a communications network.

With continued reference to FIG. 6, computing device 600 includes a bus 610 that directly or indirectly couples the following devices: memory 612, one or more processors 614, one or more presentation components 616, input/output (I/O) ports 618, I/O components 620, and an illustrative power supply 622. Bus 610 represents what may be one or more busses (such as an address bus, data bus, or a combination thereof). Although the various blocks of FIG. 6 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art and reiterate that the diagram of FIG. 6 is merely illustrative of an exemplary computing device that can be used in connection with one or more aspects of the technology described herein. Distinction is not made between such categories as “workstation,” “server,” “laptop,” “handheld device,” etc., as all are contemplated within the scope of FIG. 6 and refer to “computer” or “computing device.”

Computing device 600 typically includes a variety of computer-readable media. Computer-readable media can be any available media that can be accessed by computing device 600 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media does not comprise a propagated data signal.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 612 includes computer storage media in the form of volatile and/or nonvolatile memory. The memory 612 may be removable, non-removable, or a combination thereof. Exemplary memory includes solid-state memory, hard drives, optical-disc drives, etc. Computing device 600 includes one or more processors 614 that read data from various entities such as bus 610, memory 612, or I/O components 620. Presentation component(s) 616 present data indications to a user or other device. Exemplary presentation components 616 include a display device, speaker, printing component, vibrating component, etc. I/O ports 618 allow computing device 600 to be logically coupled to other devices, including I/O components 620, some of which may be built in.

Illustrative I/O components include a microphone, joystick, game pad, satellite dish, scanner, printer, display device, wireless device, a controller (such as a stylus, a keyboard, and a mouse), a natural user interface (NUI), and the like. In aspects, a pen digitizer (not shown) and accompanying input instrument (also not shown but which may include, by way of example only, a pen or a stylus) are provided in order to digitally capture freehand user input. The connection between the pen digitizer and processor(s) 614 may be direct or via a coupling utilizing a serial port, parallel port, and/or other interface and/or system bus known in the art. Furthermore, the digitizer input component may be a component separated from an output component such as a display device, or in some aspects, the usable input area of a digitizer may coexist with the display area of a display device, be integrated with the display device, or may exist as a separate device overlaying or otherwise appended to a display device. Any and all such variations, and any combination thereof, are contemplated to be within the scope of aspects of the technology described herein.

An NUI processes air gestures, voice, or other physiological inputs generated by a user. Appropriate NUI inputs may be interpreted as ink strokes for presentation in association with the computing device 600. These requests may be transmitted to the appropriate network element for further processing. An NUI implements any combination of speech recognition, touch and stylus recognition, facial recognition, biometric recognition, gesture recognition both on screen and adjacent to the screen, air gestures, head and eye tracking, and touch recognition associated with displays on the computing device 600. The computing device 600 may be equipped with depth cameras, such as stereoscopic camera systems, infrared camera systems, RGB camera systems, and combinations of these, for gesture detection and recognition. Additionally, the computing device 600 may be equipped with accelerometers or gyroscopes that enable detection of motion. The output of the accelerometers or gyroscopes may be provided to the display of the computing device 600 to render immersive augmented reality or virtual reality.

A computing device may include a radio 624. The radio 624 transmits and receives radio communications. The computing device may be a wireless terminal adapted to receive communications and media over various wireless networks. Computing device 600 may communicate via wireless protocols, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include a Wi-Fi® connection to a device (e.g., mobile hotspot) that provides access to a wireless communications network, such as a WLAN connection using the 802.11 protocol. A Bluetooth connection to another computing device is a second example of a short-range connection. A long-range connection may include a connection using one or more of CDMA, GPRS, GSM, TDMA, and 802.16 protocols.

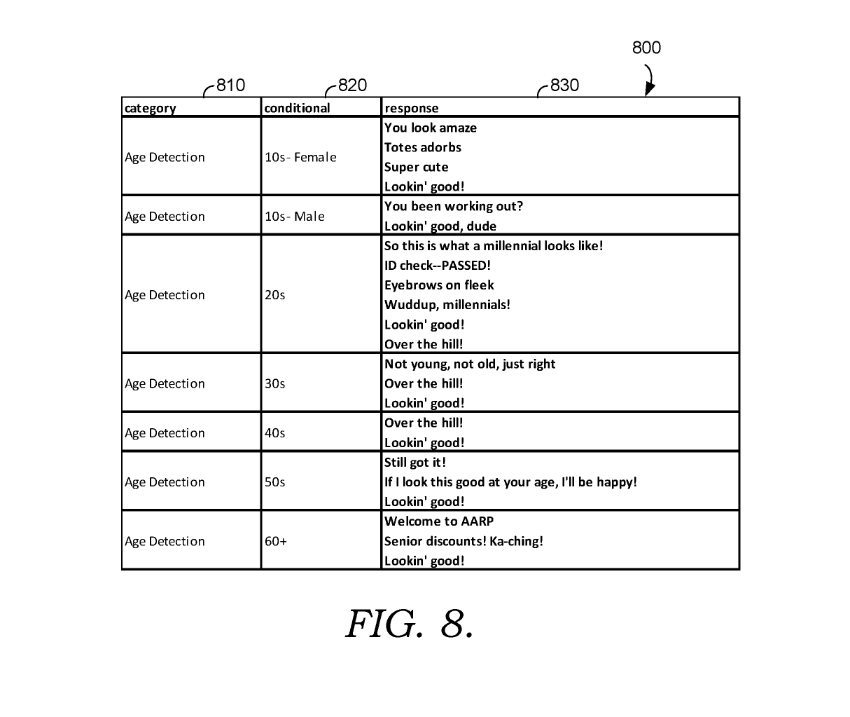

Turning now to FIGS. 8-14, tables depicting caption scenarios that could be used, for example with method 400, method 500, method 600, or other aspects of the technology described herein are provided. In FIG. 8, table 800 depicts a plurality of age-detection caption scenarios. In column 810, the category for the caption scenario is listed. In column 820, the condition for displaying a caption in conjuncture with an image or other visual media is shown. In column 830, exemplary captions that go with the condition are shown. In these caption scenarios, the condition is the age (and possibly gender) of the person depicted. For example, an image may be analyzed to determine the age of an individual depicted in the image. If the analysis indicates that the image depicts a person in his twenties, then the scenario “Looking Good!” could be displayed to the user. Aspects of the technology could randomly pick 1 of the 6 available captions to display after determining that the image depicts a person in their twenties.

The first two conditions include both an age detection and a gender detection. The first condition detects an image of a female between age 10 and 19. The second condition is a male age 10 to 19. In one scenario, the age detection algorithm is automatically run upon a person taking a selfie. In another aspect, the age detection algorithm is run by a personal assistant upon the user requesting that the personal assistant determine the age of the person in the picture.

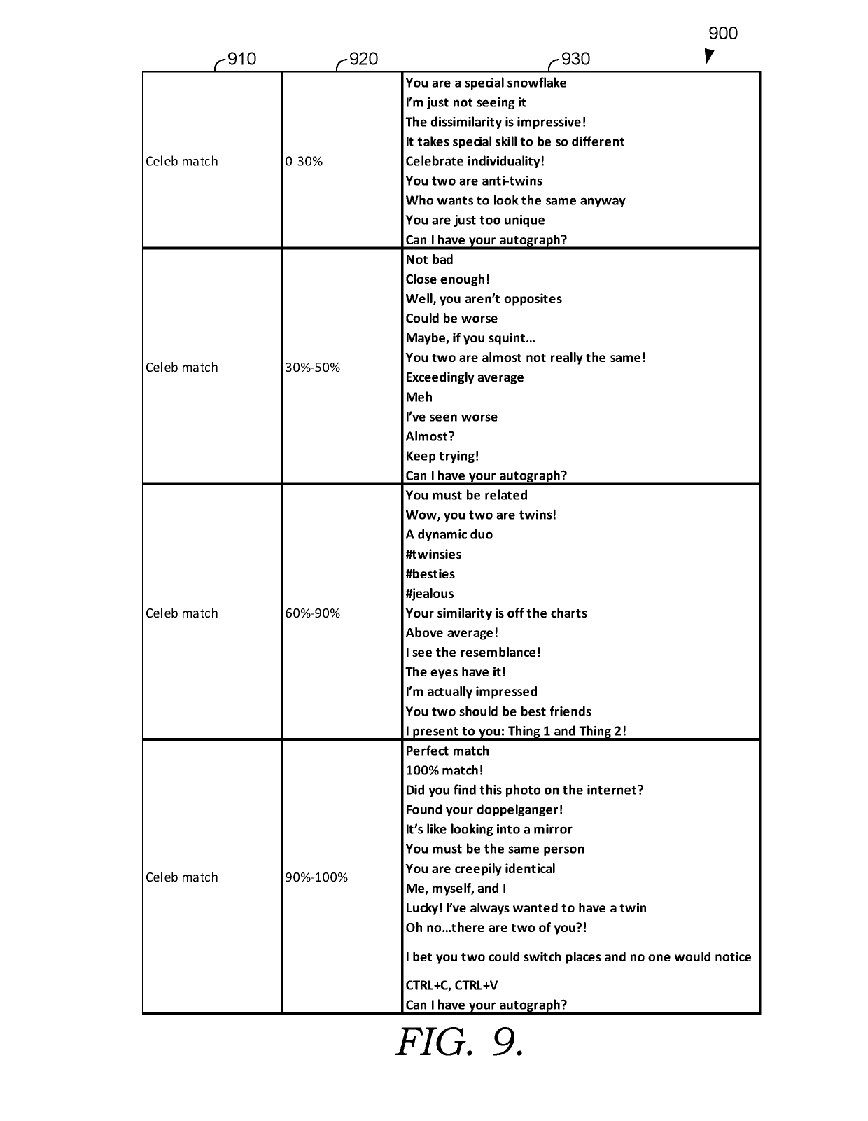

Turning now to FIG. 9, table 900 depicts several celebrity-match caption scenarios. The celebrity match caption scenarios can be activated by a user submitting a picture and the name of a celebrity. A personal assistant or other application can run a similarity analysis between one or more known images of the celebrity retrieved from a knowledge base and the picture provided. Column 920 shows the condition and column 930 shows associated captions that can be shown when the condition is triggered. Column 910 shows the category of the caption scenario.

As an example, a match between an image submitted and a celebrity that falls into the 0-30% category could cause the caption “You Are Anti-Twins” to be displayed. If the analysis returned a result in the 30-50% range, the 60-90%, or 90-100% range, respective captions could be selected for display.

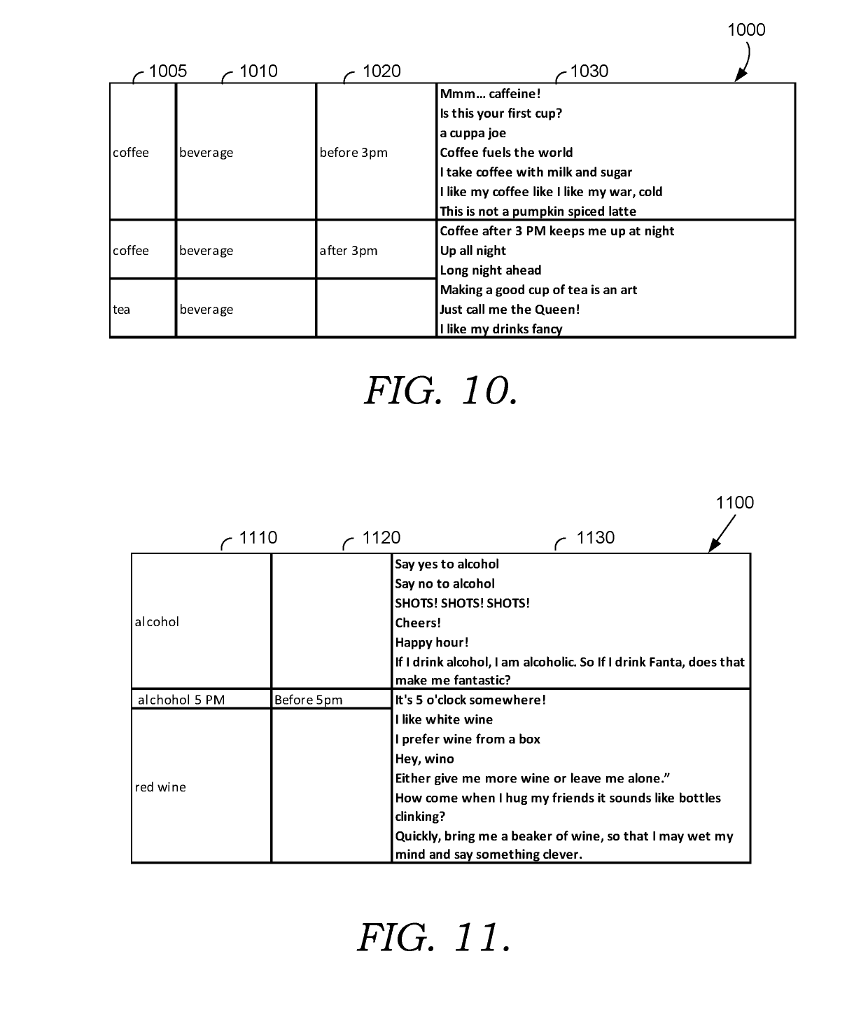

Turning now to FIG. 10, table 1000 shows a plurality of coffee-based caption scenarios. Column 1005 shows the specific drink associated with the caption scenario. The drink can be identified through image analyses and possibly the mobile device context. For example, the image could be displayed on a phone located within a coffee shop. The phone's location within a coffee shop could be determined via GPS information, Wi-Fi information, or some other type of information, including payment information. Additionally where payment information is available the information in the payment information about items purchased could be used to trigger one of the scenarios. As mentioned, column 1010 shows the category of scenario as beverage. The column 1005 shows the subcategory of beverage as either coffee or tea. The column 1020 includes a condition for one of the scenarios that the picture is displayed after 3 PM. Colum 1030 shows various captions that can be displayed upon satisfaction of the conditions. For example, when coffee is detected in a picture or through other data and it is not after 3 PM then the caption “Is This Your First Cup?” could be displayed. On the other hand, if a picture of coffee is displayed after 3 PM the caption “Long Night Ahead” could be displayed.

Turning now to FIG. 11, table 1100 shows beverage scenarios. The beverage scenario category shown in column 1110 includes a generic alcohol category, alcohol after 5 PM, and a red wine category. The column 1120 shows a condition in the case of alcohol before 5 PM. The before 5 PM condition could be determined by checking the time on a device that displays an image. The right hand column 1130 shows captions that can be displayed upon satisfaction of a particular condition. For example, upon detecting that the mobile device is located in an establishment that serves alcohol and determining that a picture on the display includes a picture of an alcoholic beverage then the caption “Happy Hour!” could be displayed.

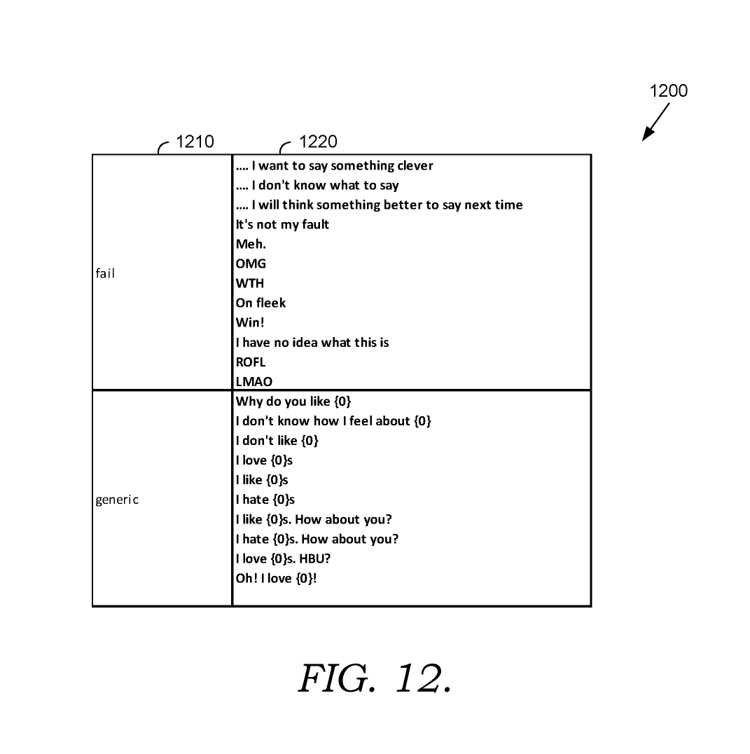

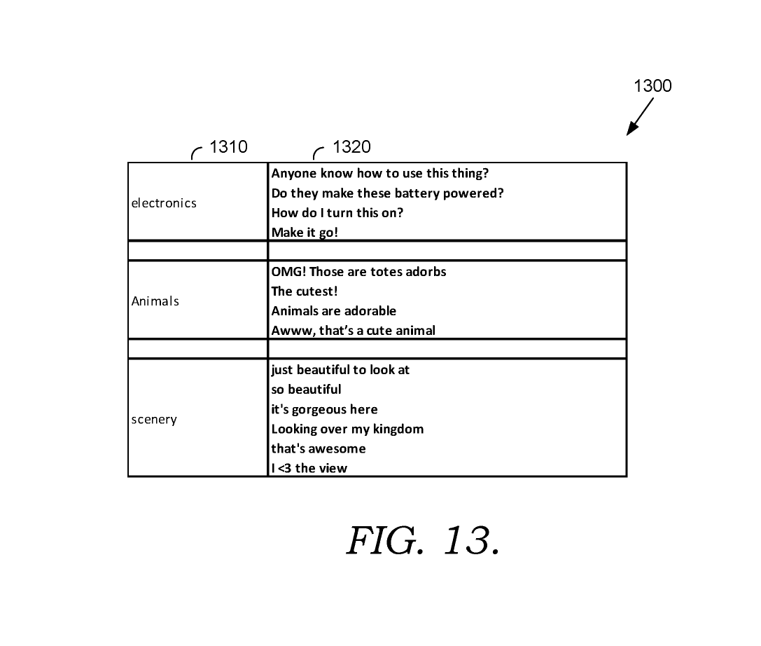

Turning now to FIG. 12, table 1200 shows situation-based caption scenarios. Column 1210 shows the category of caption scenario as either fail or generic. Column 1220 shows exemplary captions. In one aspect, if a fail situation, such as somebody laying on the ground or acting silly, is detected in an image, possibly in combination with the context of a communication or other device information, then a fail situation could be detected and a corresponding caption displayed.

The generic captions include an object insertion points indicated by the bracketed zero {0}. In each of the caption scenarios shown, an object detected in an image could be inserted into the object insertion points to form a caption. For example, if broccoli is detected in an image then the caption “Why Do You Like Broccoli” could be displayed.

Turning now to FIG. 13, table 1300 shows object-based caption scenarios. Column 1310 shows the object in question as, either electronics, animals, or scenery. Corresponding captions are displayed in column 1320. The scenarios shown in table 1300 could be triggered upon detecting an image of electronics, animals, or scenery. As mentioned previously, an image classifier could be used to classify or identify these types of objects within an image.

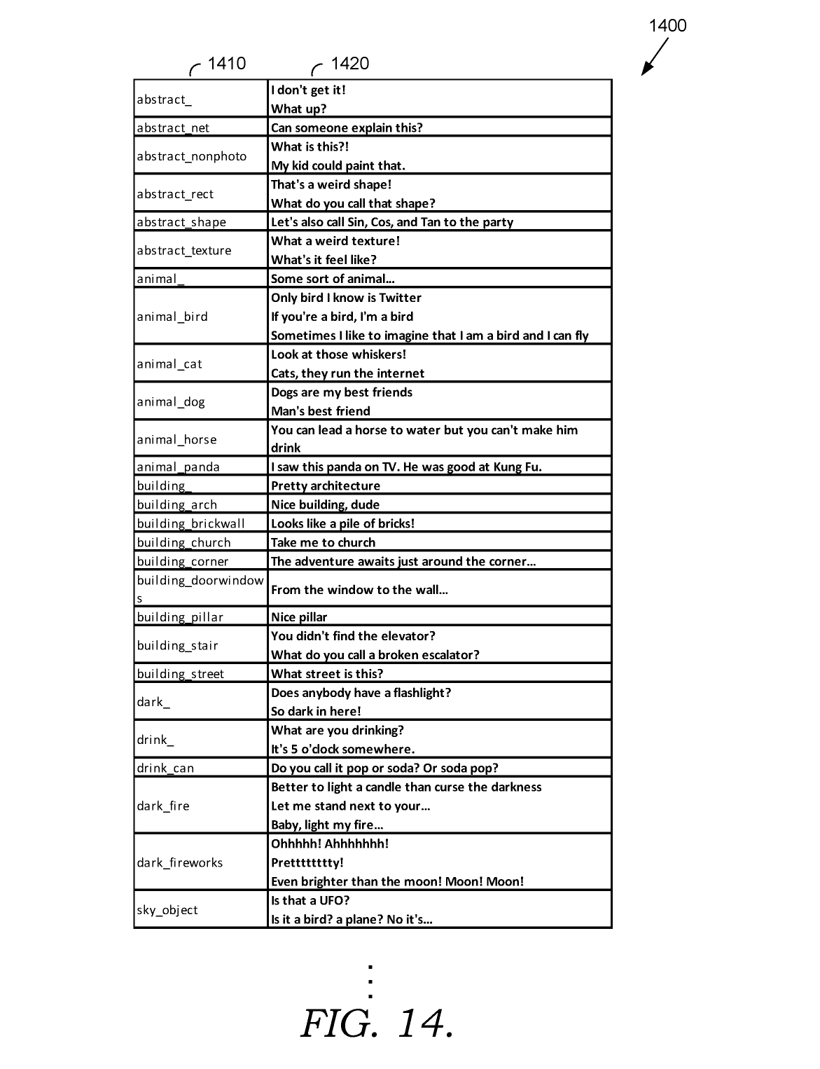

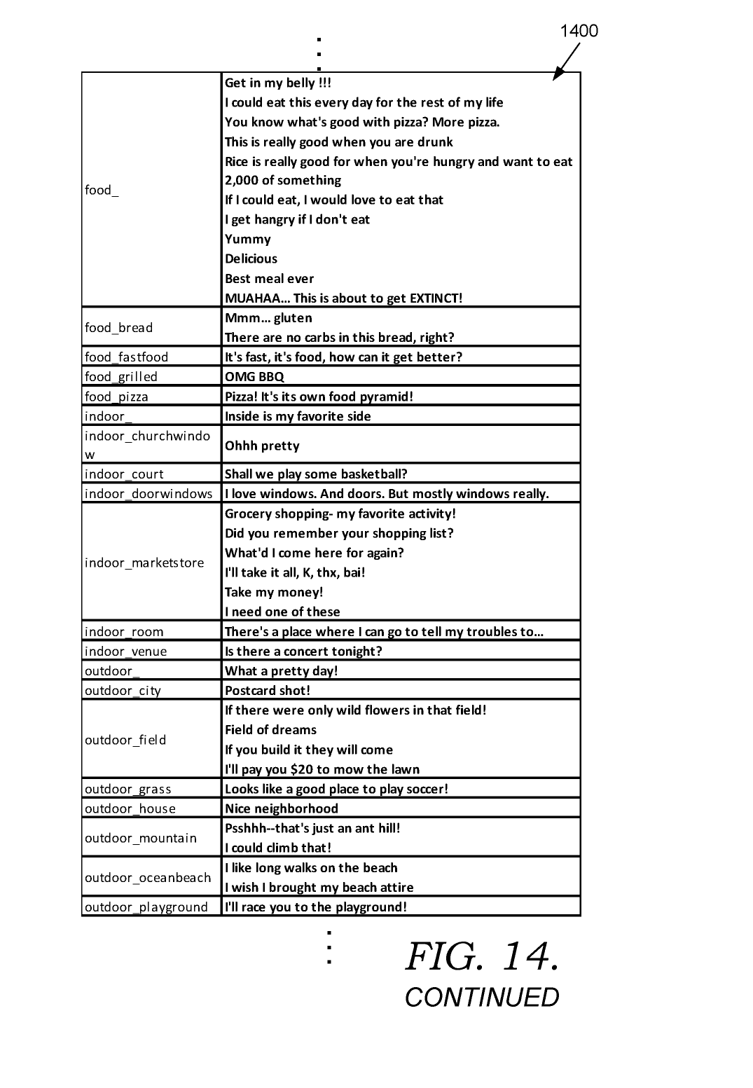

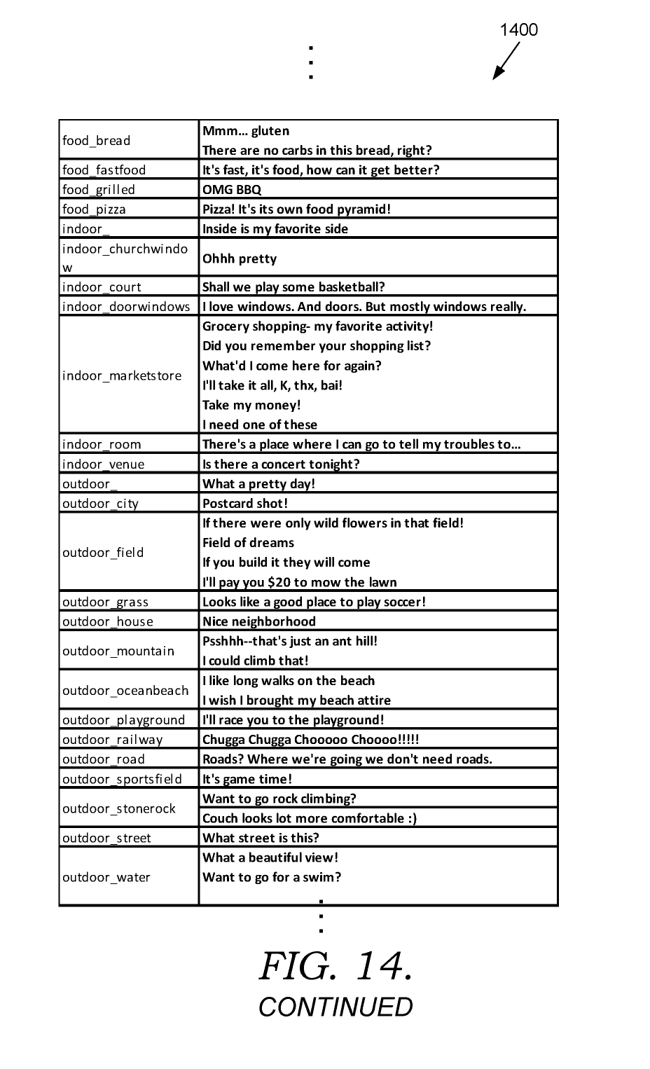

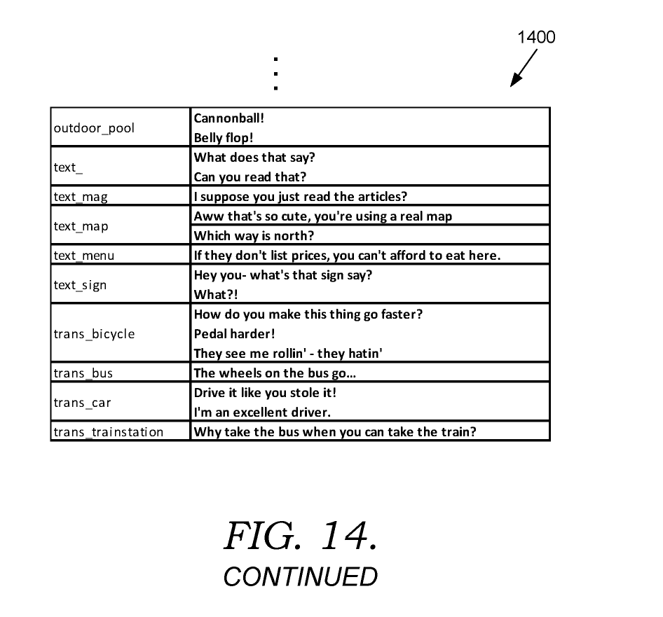

Turning now to FIG. 14, table 1400 includes miscellaneous caption scenarios. Column 1410 includes the type of scenario or description of the object or situation identified and column 1420 shows corresponding captions. Each caption could be associated with a test to determine that an image along with the context of the phone satisfies a trigger to show the corresponding caption.

### EMBODIMENTS

### Embodiment 1

A computing system comprising: a processor; and computer storage memory having computer-executable instructions stored thereon which, when executed by the processor, configure the computing system to: identify an object in a visual media that is displayed on the computing device; analyze signal data from the computing device to determine a context of the visual media; map the object and the context to a caption scenario; generate a caption for the visual media using the caption scenario; and output the caption and the visual media for display through the computing device.

### Embodiment 2

The system of embodiment 1, wherein the visual media is an image.

### Embodiment 3

The system as in any one of the above embodiments, wherein the caption scenario includes text having a text insertion point for one or more terms related to the context.

### Embodiment 4

The system as in any one of the above embodiments, wherein the computing system is further configured to present multiple objects in the visual media for selection and receive a user selection of the object.

### Embodiment 5

The system as in any one of the above embodiments, wherein the computing system is further configured to analyze the visual media using a machine classifier to identify the object.

### Embodiment 6

The system as in any one of the above embodiments, wherein the visual media is received from another user.

### Embodiment 7

The system as in any one of the above embodiments, wherein the computing system is further configured to provide an interface that allows a user to modify the caption.

### Embodiment 8

A method of generating a caption for a visual media, the method comprising: identifying an object in the visual media that is displayed on a computing device; analyzing signal data from the computing device to determine a context of the computing device; generating a caption for the visual media using the object and the context; and outputting the caption and the visual media for display.

### Embodiment 9

The method of embodiment 8, wherein the generating the caption further comprises: mapping the object and the context to a caption scenario, the caption scenario associated with a caption template that includes text and an object insertion point; and inserting a description of the object into the caption template to form the caption.

### Embodiment 10

The method of embodiment 9, wherein the caption template further comprises a context insertion point; and wherein the method further comprises inserting a description of the context into the context insertion point to form the caption.

### Embodiment 11

The method as in any one of embodiment 8, 9, or 10, wherein the context is an event depicted in the visual media and the context indicates the event is contemporaneous to the visual media being displayed on the computing device.

### Embodiment 12

The method as in any one of embodiment 8, 9, 10, or 11, wherein the signal data is location data.

### Embodiment 13

The method as in any one of embodiment 8, 9, 10, 11, or 12, wherein the context is an exercise event has been completed within a threshold period of time from the visual media being displayed on the computing device.

### Embodiment 14

The method as in any one of embodiment 8, 9, 10, 11, 12, or 13, wherein the signal data is fitness data.

### Embodiment 15

The method as in any one of embodiment 8, 9, 10, 11, 12, 13, or 14, wherein the method further comprises determining that a user of the computing device is associated with an event pattern consistent with the context, the event pattern comprising drafting a caption for a previously displayed visual media.

### Embodiment 16

A method of providing a caption for an image comprising: determining that a user is interacting with an image through a computing device; determining a present context for the image by analyzing signal data received by the computing device; determining that above a threshold similarity exists between the present context for the image and past contexts when the user has previously associated a previous caption with a previous image; identifying an object in the image; generating a caption for the image using the object and the present context; and outputting the caption and the image for display.

### Embodiment 17

The method of embodiment 16, wherein the caption is an overlay embedded in the image.

### Embodiment 18

The method as in any one embodiments 16 or 17, wherein the caption is a social post associated with the image.

### Embodiment 19

The method as in any one embodiments 16, 17, or 18, wherein the method further comprises receiving an instruction to post the caption and the image to a social media platform and posting the caption and the image to the social media platform.

### Embodiment 20

The method as in any one embodiments 16, 17, 18, or 19, wherein the method further comprises receiving a modification to the caption.

Aspects of the technology have been described to be illustrative rather than restrictive. It will be understood that certain features and subcombinations are of utility and may be employed without reference to other features and subcombinations. This is contemplated by and is within the scope of the claims.

The invention claimed is:

1. A computing system comprising:
a processor; and
computer storage memory having computer-executable instructions stored thereon which, when executed by the processor, configure the computing system to:
identify an object in a visual media that is displayed on the computing device;
analyze signal data from the computing device to determine a context of the visual media;
map the object and the context to a caption scenario;
generate a caption for the visual media using the caption scenario; and
output the caption and the visual media for display through the computing device.

2. The system of claim 1, wherein the visual media is an image.

3. The system of claim 1, wherein the caption scenario includes text having a text insertion point for one or more terms related to the context.

4. The system of claim 1, wherein the computing system is further configured to present multiple objects in the visual media for selection and receive a user selection of the object.

5. The system of claim 1, wherein the computing system is further configured to analyze the visual media using a machine classifier to identify the object.

6. The system of claim 1, wherein the visual media is received from another user.

7. The system of claim 1, wherein the computing system is further configured to provide an interface that allows a user to modify the caption.

8. A method of generating a caption for a visual media, the method comprising:
identifying an object in the visual media that is displayed on a computing device;
analyzing signal data from the computing device to determine a context of the computing device;
generating a caption for the visual media using the object and the context; and
outputting the caption and the visual media for display.

9. The method of claim 8, wherein the generating the caption further comprises:
mapping the object and the context to a caption scenario, the caption scenario associated with a caption template that includes text and an object insertion point; and
inserting a description of the object into the caption template to form the caption.

10. The method of claim 9, wherein the caption template further comprises a context insertion point; and
wherein the method further comprises inserting a description of the context into the context insertion point to form the caption.

11. The method of claim 8, wherein the context is an event depicted in the visual media and the context indicates the event is contemporaneous to the visual media being displayed on the computing device.

12. The method of claim 8, wherein the signal data is location data.

13. The method of claim 8, wherein the context is an exercise event has been completed within a threshold period of time from the visual media being displayed on the computing device.

14. The method of claim 8, wherein the signal data is fitness data.

15. The method of claim 8, wherein the method further comprises determining that a user of the computing device is associated with an event pattern consistent with the context, the event pattern comprising drafting a caption for a previously displayed visual media.

16. A method of providing a caption for an image comprising:
determining that a user is interacting with an image through a computing device;
determining a present context for the image by analyzing signal data received by the computing device;
determining that above a threshold similarity exists between the present context for the image and past contexts when the user has previously associated a previous caption with a previous image;
identifying an object in the image;
generating a caption for the image using the object and the present context; and
outputting the caption and the image for display.

17. The method of claim 16, wherein the caption is an overlay embedded in the image.

18. The method of claim 16, wherein the caption is a social post associated with the image.

19. The method of claim 18, wherein the method further comprises receiving an instruction to post the caption and the image to a social media platform and posting the caption and the image to the social media platform.

20. The method of claim 16, wherein the method further comprises receiving a modification to the caption.
